(19) United States
(12) Patent Application Publication
(10) Pub. No.: US 2014/0056356 A1
(43) Pub. Date: Feb. 27, 2014

(54) METHOD AND APPARATUS FOR EFFICIENT SIGNALING OF WEIGHTED PREDICTION IN ADVANCED CODING SCHEMES

(71) Applicant: Motorola Mobility LLC, Libertyville, IL (US)

(72) Inventors: Yue Yu, San Diego, IL (US); Jian Lou, San Diego, IL (US); Limin Wang, San Diego, CA (US)

(73) Assignee: Motorola Mobility LLC, Libertyville, IL (US)

(21) Appl. No.: 13/972,017

(22) Filed: Aug. 21, 2013

Related U.S. Application Data
(60) Provisional application No. 61/691,794, filed on Aug. 21, 2012.
(60) Provisional application No. 61/691,800, filed on Aug. 22, 2012.
(60) Provisional application No. 61/711,211, filed on Oct. 9, 2012.

(51) Int. Cl. H04N 7/36

(52) U.S. Cl. CPC H04N 19/00587
USPC 375/240.16

(57) ABSTRACT

A method for signaling weighted prediction processing in advanced coding schemes is disclosed. Signaling is removed from the picture parameter set hierarchical level and instead inserted in the slice header, and a single flag is used to signal weighted prediction for both P slices and B slices, thereby simplifying operation and increasing bit efficiency.

### CROSS-REFERENCE TO RELATED APPLICATIONS

This application claims the benefit of the following U.S. Provisional Patent Applications, both of which are hereby incorporated by reference: 61/691,794, filed Aug. 21, 2012, 61/691,800, filed Aug. 22, 2012 and 61/711,211, filed Oct. 9, 2012.

### BACKGROUND

The present invention relates to systems and methods for encoding data and in particular to a system and method for generating and processing slice headers with high efficiency video-coded data.

There is rapid growth in the technologies associated with the generation, transmission, and reproduction of media programs. These technologies include coding schemes that permit digital versions of the media programs to be encoded to compress them to much smaller size and to facilitate their transmission, storage, reception, and playback. These technologies have application in personal video recorders, video on demand, multiple channel media program offerings, interactivity, mobile telephony, and media program transmission.

Without compression, digital media programs are typically too large to transmit or store for a commercially acceptable cost. However, compression of such programs has made the transmission and storage of such digital media programs not only commercially feasible, but commonplace.

Initially, the transmission of media programs involved low to medium resolution images transmitted over high bandwidth transmission media such as cable television and satellite. However, such transmission has evolved to include lower bandwidth transmission media such as Internet transmission to fixed and mobile devices via computer networks, WiFi, Mobile TV, and third and fourth generation networks. Further, such transmissions have also evolved to include high definition media programs such as high definition television, which have significant transmission bandwidth and storage requirements.

The High Efficiency Video Coding (“HEVC”) coding standard (also called H.265) is the most recent coding standard promulgated by the ISO/IEC MPEG standardization organizations. The coding standards preceding HEVC include the H.262/MPEG-2 and the subsequent H.264/MPEG-4 Advanced Video Coding (“AVC”) standard. H.264/MPEG-4 has substantially replaced H.262/MPEG-2 in many applications including high definition television. HEVC supports resolutions higher than “high definition,” even in stereo or multi-view embodiments, and is more suitable for mobile devices such as tablet personal computers.

As in other coding standards, the bitstream structure and syntax of HEVC compliant data are standardized, such that every decoder conforming to the standard will produce the same output when provided with the same input. Some of the features incorporated into the HEVC standard include the definition and processing of a slice, one or more of which may together compose one of the pictures in a video sequence. A video sequence comprises a plurality of pictures, and each picture may comprise one or more slices. Slices include non-dependent slices and dependent slices. A non-dependent slice (hereinafter simply referred to as a slice) is a data structure that can be decoded independently from other slices of the same picture in terms of entropy encoding, signal prediction, and residual signal construction. This data structure permits resynchronization of events in case of data losses. A “dependent slice” is a structure that permits information about the slice (such as those related with tiles within the slice or wavefront entries) to be carried to the network layer, thus making that data available to a system to more quickly process fragmented slices. Dependent slices are mostly useful for low-delay encoding.

HEVC and legacy coding standards define a parameter set structure that offers improved flexibility for operation over a wide variety of applications and network environments and improved robustness to data losses. Parameter sets contain information that can be shared for decoding of different portions of the encoded video. The parameter set structure provides a secure mechanism for conveying data that is essential to the decoding process. H.264 defined both sequence parameter sets (“SPSs”) that describe parameters for decoding a sequence of pictures and a picture parameter set (“PPS”) that describes parameters for decoding a picture of the sequence of pictures. HEVC introduces a new parameter set, the video parameter set (“VPS”).

The encoding and decoding of slices is performed according to information included in a slice header. The slice header includes syntax and logic for reading flags and data that are used in decoding the slice.

Like its predecessors, HEVC supports both temporal and spatial encoding of picture slices. HEVC defines slices to include I-slices, which are spatially, but not temporally, encoded with reference to another slice. I-slices are alternatively described as “intra” slice encoded. HEVC also defines slices to include P (predictive) slices, which are spatially encoded and temporally encoded with reference to another slice. P-slices are alternatively described as “inter” slice encoded. HEVC also describes slices to include bi-predictive (“B”)-slices. B-slices are spatially encoded and temporally encoded with reference to two or more other slices. Further, HEVC consolidates the notion of P and B slices into general B slices that can be used as reference slices.

Currently, the PPS includes two syntaxes, weighted_pred_flag and weighte_bipred_flag. A weighted_pred_flag value of 0 specifies that weighted prediction shall not be applied to P slices, whereas a weighted_pred_flag of 1 specifies that weighted prediction shall be applied to P slices. Similarly, a weighted_bipred_flag value of 0 specifies that the default weighted prediction is applied to B slices, while a weighted_bipred_flag value of 1 specifies that weighted prediction is applied to B slices.

Although the above described weighted prediction flags are coded in PPS, the specific weighted prediction parameters are coded in the slice header. The result is that the flags controlling the weighted prediction processing and the weighted prediction parameters are on different hierarchical levels of coding (picture versus slice), and this can create logical difficulties which unnecessarily make slice header or PPS logic more complex or redundant, as not all slices within a picture require weighed prediction. In some scenarios, it may also cause wasted bits. For example, if the weighted prediction enabling flag is coded as 1 at PPS for a picture, then the weighted prediction parameters have to be coded at the slice header for each slice of the picture. This is even true for 1 slices, which do not perform weighted prediction.

Since any given video stream typically includes thousands of pictures, and each picture may contain one or more slices, the syntax and logic used in the header can have a significant impact on the processing load performed to encode and later decode the video stream.

### SUMMARY

This document discloses a method usable in a processing system for decoding a sequence comprising a plurality of pictures, each of the plurality of pictures partitionable into one or more slices, each of the pictures processed at least in part according to a picture parameter set, and each of the slices processed at least in part according to a slice header. In one embodiment, the method comprises determining if a slice of the one or more slices is an inter-predicted slice according to slice-type data, and if the slice is determined to be an inter-predicted slice, determining if a first parameter is in the slice header, the first parameter associated with a value signaling enablement of a state of weighted prediction of image data associated with the slice. If the first parameter is in the slice header, then the first parameter is read and used to perform weighted prediction of the image data according to the read first parameter.

### BRIEF DESCRIPTION OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a diagram depicting an exemplary embodiment of a video coding/decoding system that can be used for transmission or storage and retrieval of audio or video information;

FIG. 2A is a diagram of one embodiment of an encoding/decoding (“codec”) system in which encoded audio/visual (“AV”) information is transmitted to and received at another location;

FIG. 2B is a diagram depicting an exemplary embodiment of a codec system in which the encoded information is stored and later retrieved for presentation, hereinafter referred to as a codec storage system;

FIG. 2C is a diagram depicting an exemplary content-distribution system comprising an encoder and a decoder that can be used to transmit and receive HEVC data;

FIG. 3 is a block diagram illustrating one embodiment of a source encoder;

FIG. 4 is a diagram depicting a picture of AV information, such as one of the pictures in the picture sequence;

FIG. 5 is a diagram showing an exemplary partition of a coding-tree block into coding units;

FIG. 6 is a diagram illustrating a representative quadtree and data parameters for the coding-tree block partitioning shown in FIG. 5;

FIG. 7 is a diagram illustrating the partition of a coding unit into one or more prediction units;

FIG. 8 is a diagram showing a coding unit partitioned into four prediction units and an associated set of transform units;

FIG. 9 is a diagram showing a Residual QuadTree (“RQT”) for the transform units associated with the coding unit in the example of FIG. 8;

FIG. 10 is a diagram illustrating spatial prediction of prediction units;

FIG. 11 is a diagram illustrating temporal prediction;

FIG. 12 is a diagram illustrating the use of motion vector predictors (“MVPs”);

FIG. 13 is an example of the use of the reference picture lists;

FIG. 14 is a diagram illustrating processes performed by the encoder according to the aforementioned standard;

FIG. 15 depicts the use of a the collocated_from_{—}10_flag by the decoder according to the emerging HEVC standard;

FIGS. 16A and 16B are diagrams presenting a baseline PPS syntax;

FIGS. 17A through 17C are diagrams presenting baseline slice header logic and syntax;

FIGS. 18A and 18B are diagrams illustrating one embodiment of an improved PPS syntax;

FIGS. 19A through 19C are syntax diagrams illustrating one embodiment of an improved slice header syntax for use with the improved PPS syntax;

FIGS. 20A and 20B are diagrams illustrating exemplary operations that can be performed in accordance with the slice header shown in FIGS. 19A through 19C; and

FIG. 21 illustrates an exemplary processing system that could be used to implement embodiments of the invention.

### DETAILED DESCRIPTION OF PREFERRED EMBODIMENTS

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

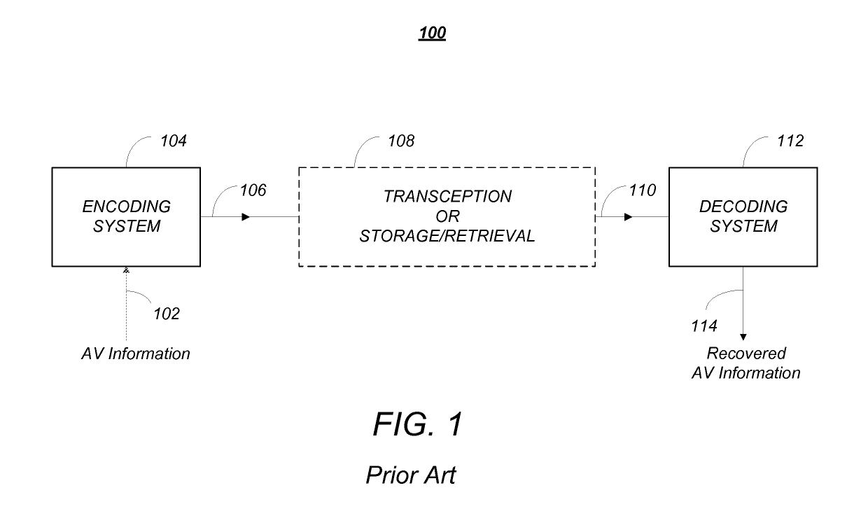

FIG. 1 is a diagram depicting an exemplary embodiment of a codec system 100 that can be used for transmission or storage and retrieval of audio or video information. The codec system 100 comprises an encoding system 104, which accepts AV information 102 and processes the AV information 102 to generate encoded (compressed) AV information 106. A decoding system 112 processes the encoded AV information 106 to produce recovered AV information 114. Since the encoding and decoding processes are not lossless, the recovered AV information 114 is not identical to the initial AV information 102, but with judicious selection of the encoding processes and parameters, the differences between the recovered AV information 114 and the unprocessed AV information 102 are acceptable to human perception.

The encoded AV information 106 is typically transmitted or stored and retrieved before decoding and presenting, as performed by “transception” (transmission and reception) or storage/retrieval system 108. Transception losses may be significant, but storage/retrieval losses are typically minimal or non-existent, hence, the transcepted AV information 110 provided to the decoding system 112 is typically the same as or substantially the same as the encoded AV information 106.

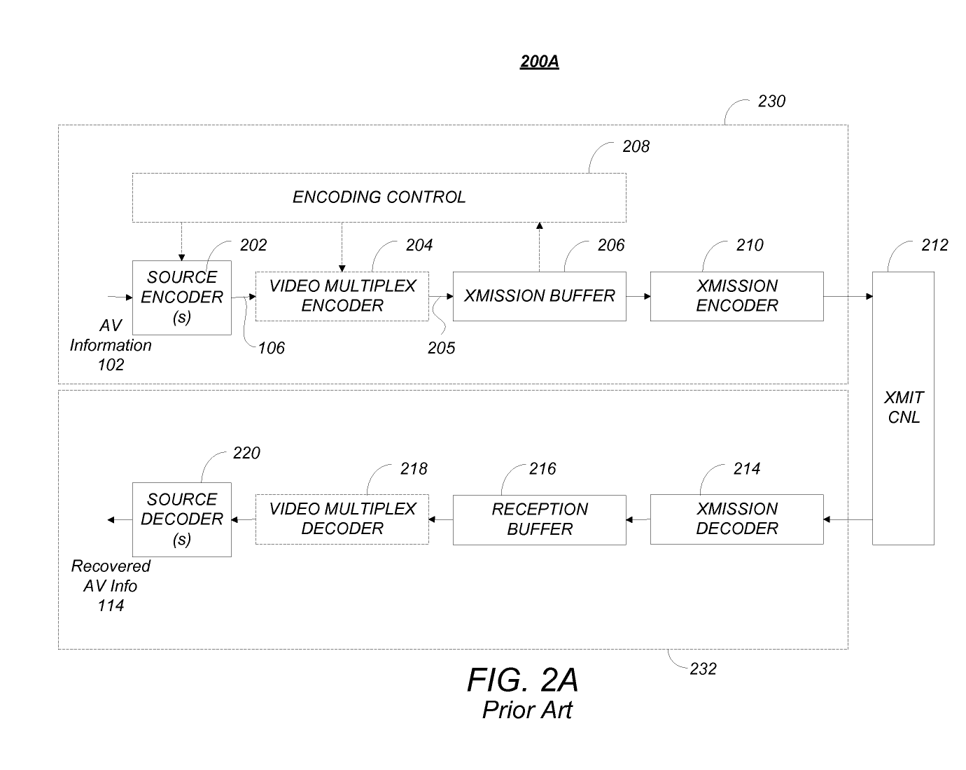

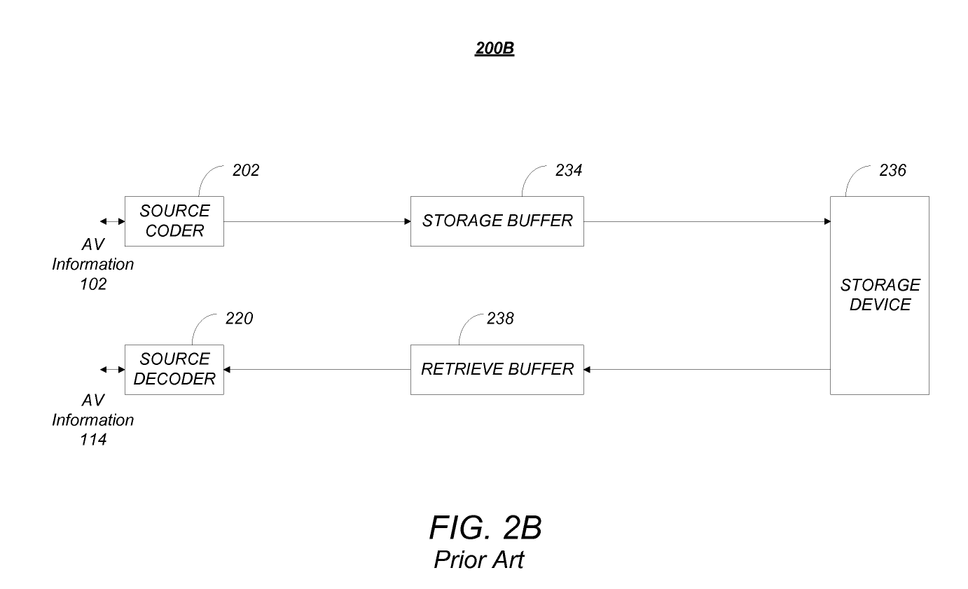

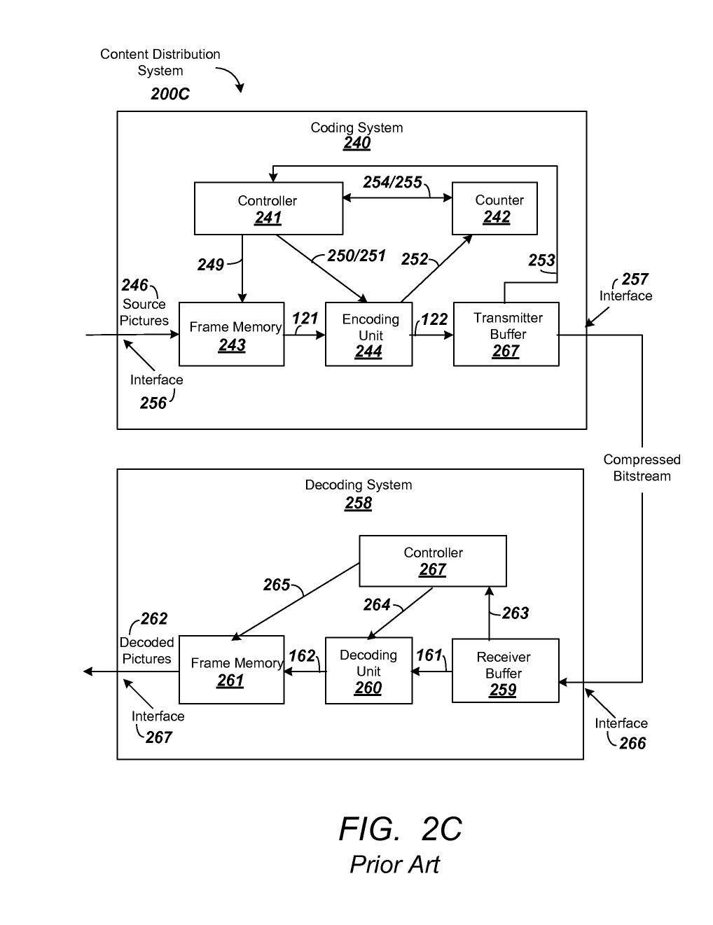

FIG. 2A is a diagram of one embodiment of a codec system 200A in which the encoded AV information 106 is transmitted to and received at another location. A transmission segment 230 converts input AV information 102 into a signal appropriate for transmission and transmits the converted signal over the transmission channel 212 to the reception segment 232. The reception segment 232 receives the transmitted signal and converts the received signal into the recovered AV information 114 for presentation. As described above, due to coding and transmission losses and errors, the recovered AV information 114 may be of lower quality than the AV information 102 that was provided to the transmission segment 230. However, error-correcting systems may be included to reduce or eliminate such errors. For example, the encoded AV information 106 may be forward-error correction (“FEC”) encoded by adding redundant information, and such redundant information can be used to identify and eliminate errors in the reception segment 232.

The transmission segment 230 comprises one or more source encoders 202 to encode multiple sources of AV information 102. The source encoder 202 encodes the AV information 102 primarily for purposes of compression to produce the encoded AV information 106 and may include, for example, a processor and related memory storing instructions implementing a codec such as MPEG-1, MPEG-2, MPEG-4 AVC/H.264, HEVC, or a similar codec, as described further below.

The codec system 200A may also include optional elements indicated by the dashed lines in FIG. 2A. These optional elements include a video multiplex encoder 204, an encoding controller 208, and a video demultiplexing decoder 218. The optional video multiplex encoder 204 multiplexes encoded AV information 106 from an associated plurality of source encoders 202 according to one or more parameters supplied by the optional encoding controller 208. Such multiplexing is typically accomplished in the time domain and is data-packet based.

In one embodiment, the video multiplex encoder 204 comprises a statistical multiplexer, which combines the encoded AV information 106 from a plurality of source encoders 202 so as to minimize the bandwidth required for transmission. This is possible because the instantaneous bit rate of the coded AV information 106 from each source encoder 202 can vary greatly with time according to the content of the AV information 102. For example, scenes having a great deal of detail and motion (e.g., sporting events) are typically encoded at higher bitrates than scenes with little motion or detail (e.g., portrait dialog). Since each source encoder 202 may produce information with a high instantaneous bitrate while another source encoder 202 produces information with a low instantaneous bit rate, and since the encoding controller 208 can command the source encoders 202 to encode the AV information 106 according to certain performance parameters that affect the instantaneous bit rate, the signals from each of the source encoders 202 (each having a temporally varying instantaneous bit rate) can be combined together in an optimal way to minimize the instantaneous bit rate of the multiplexed stream 205.

As described above, the source encoder 202 and the video multiplex coder 204 may optionally be controlled by a coding controller 208 to minimize the instantaneous bit rate of the combined video signal. In one embodiment, this is accomplished using information from a transmission buffer 206 which temporarily stores the coded video signal and can indicate the fullness of the buffer 206. This allows the coding performed at the source encoder 202 or at the video multiplex coder 204 to be a function of the storage remaining in the transmission buffer 206.

The transmission segment 230 also may comprise a transmission encoder 210 which further encodes the video signal for transmission to the reception segment 232. Transmission encoding may include for example, the aforementioned FEC coding or coding into a multiplexing scheme for the transmission medium of choice. For example, if the transmission is by satellite or terrestrial transmitters, then the transmission encoder 210 may encode the signal into a signal constellation before transmission via quadrature amplitude modulation or a similar modulation technique. Also, if the encoded video signal is to be streamed via an Internet protocol device and the Internet, then the transmission encodes the signal according to the appropriate protocol. Further, if the encoded signal is to be transmitted via mobile telephony, then the appropriate coding protocol is used, as further described below.

The reception segment 232 comprises a transmission decoder 214 to receive the signal that was coded by the transmission coder 210 using a decoding scheme complementary to the coding scheme used in the transmission encoder 210. The decoded received signal may be temporarily stored by an optional reception buffer 216, and if the received signal comprises multiple video signals, then the received signal is multiplex-decoded by the video multiplex decoder 218 to extract the video signal of interest from the video signals multiplexed by the video multiplex coder 204. Finally, the video signal of interest is decoded by source decoder 220 using a decoding scheme or codec complementary to the codec used by the source encoder 202 to encode the AV information 102.

In one embodiment, the transmitted data comprise a packetized video stream transmitted from a server (representing the transmitting segment 230) to a client (representing the receiving segment 232). In this case, the transmission encoder 210 may packetize the data and embed Network Abstract Layer (“NAL”) units in network packets. NAL units define a data container that has header and coded elements and may correspond to a video frame or other slice of video data.

The compressed data to be transmitted may be packetized and transmitted via transmission channel 212, which may include a Wide Area Network or a Local Area Network. Such a network may comprise, for example, a wireless network such as WiFi, an Ethernet network, an Internet network, or a mixed network composed of several different networks. Such communication may be affected via a communication protocol, for example Real-time Transport Protocol, User Datagram Protocol, or any other type of communication protocol. Different packetization methods may be used for each NAL unit of the bitstream. In one case, one NAL unit size is smaller than the maximum transport unit size corresponding to the largest packet size that can be transmitted over the network without being fragmented. In this case, the NAL unit is embedded into a single network packet. In another case, multiple entire NAL units are included in a single network packet. In a third case, one NAL unit may be too large to be transmitted in a single network packet and is thus split into several fragmented NAL units with each fragmented NAL unit being transmitted in an individual network packet. Fragmented NAL unit are typically sent consecutively for decoding purposes.

The reception segment 232 receives the packetized data and reconstitutes the NAL units from the network packet. For fragmented NAL units, the client concatenates the data from the fragmented NAL units in order to reconstruct the original NAL unit. The client 232 decodes the received and reconstructed data stream and reproduces the video images on a display device and the audio data by a loud speaker.

FIG. 2B is a diagram depicting an exemplary embodiment of a codec system in which the encoded information is stored and later retrieved for presentation, hereinafter referred to as codec storage system 200B. This embodiment may be used, for example, to locally store information in a digital video recorder, a flash drive, hard drive, or similar device. In this embodiment, the AV information 102 is source-encoded by source encoder 202 and optionally buffered by storage buffer 234 before storage in a storage device 236. The storage device 236 may store the video signal temporarily or for an extended period of time and may comprise a hard drive, flash drive, random-access memory (“RAM”), or read-only memory (“ROM”). The stored AV information is then retrieved, optionally buffered by retrieve buffer 238, and decoded by the source decoder 220.

FIG. 2C is another diagram depicting an exemplary content-distribution system 200C comprising a coding system 240 and a decoding system 258 that can be used to transmit and receive HEVC data. In some embodiments, the coding system 240 can comprise an input interface 256, a controller 241, a counter 242, a frame memory 243, an encoding unit 244, a transmitter buffer 267, and an output interface 257. The decoding system 258 can comprise a receiver buffer 259, a decoding unit 260, a frame memory 261, and a controller 267. The coding system 240 and the decoding system 258 can be coupled with each other via a transmission path which can carry a compressed bit stream. The controller 241 of the coding system 240 can control the amount of data to be transmitted on the basis of the capacity of the transmitter buffer 267 or receiver buffer 259 and can include other parameters such as the amount of data per unit of time. The controller 241 can control the encoding unit 244 to prevent the occurrence of a failure of the decoding system 258. The controller 241 can be a processor or can include, by way of a non-limiting example, a microcomputer having a processor, RAM, and ROM.

Source pictures 246 supplied from a content provider can include a video sequence of frames including source pictures in a video sequence. The source pictures 246 can be uncompressed or compressed. If the source pictures 246 are uncompressed, then the coding system 240 can have an encoding function. If the source pictures 246 are compressed, then the coding system 240 can have a transcoding function. Coding units can be derived from the source pictures utilizing the controller 241. The frame memory 243 can have a first area that can be used for storing the incoming frames from the source pictures 246 and a second area that can be used for reading out the frames and outputting them to the encoding unit 244. The controller 241 can output an area switching control signal 249 to the frame memory 243. The area switching control signal 249 can indicate whether the first area or the second area is to be utilized.

The controller 241 can output an encoding control signal 250 to the encoding unit 244. The encoding control signal 250 can cause the encoding unit 244 to start an encoding operation, such as preparing the Coding Units based on a source picture. In response to the encoding control signal 250 from the controller 241, the encoding unit 244 can begin to read out the prepared Coding Units to a high-efficiency encoding process, such as a prediction coding process or a transform coding process, which processes the prepared Coding Units generating video compression data based on the source pictures associated with the Coding Units.

The encoding unit 244 can package the generated video compression data in a packetized elementary stream including video packets. The encoding unit 244 can map the video packets into an encoded video signal 122 using control information and a program time stamp, and the encoded video signal 122 can be transmitted to the transmitter buffer 267.

The encoded video signal 122, including the generated video compression data, can be stored in the transmitter buffer 267. The information amount counter 242 can be incremented to indicate the total amount of data in the transmitter buffer 267. As data are retrieved and removed from the buffer, the counter 242 can be decremented to reflect the amount of data in the transmitter buffer 267. The occupied area information signal 253 can be transmitted to the counter 242 to indicate whether data from the encoding unit 244 has been added to or removed from the transmitter buffer 267 so the counter 242 can be incremented or decremented. The controller 241 can control the production of video packets produced by the encoding unit 244 on the basis of the occupied area information 253, which can be communicated in order to anticipate, avoid, prevent, or detect an overflow or underflow from taking place in the transmitter buffer 267.

The information amount counter 242 can be reset in response to a preset signal 254 generated by the controller 241. After the information amount counter 242 is reset, it can count data output by the encoding unit 244 and obtain the amount of video compression data or video packets which have been generated. The information amount counter 242 can supply the controller 241 with an information amount signal 255 representative of the obtained amount of information. The controller 241 can control the encoding unit 244 so that there is no overflow at the transmitter buffer 267.

In some embodiments, the decoding system 258 can comprise an input interface 266, a receiver buffer 259, a controller 267, a frame memory 261, a decoding unit 260, and an output interface 267. The receiver buffer 259 of the decoding system 258 can temporarily store the compressed bit stream including the received video compression data and video packets based on the source pictures from the source pictures 246. The decoding system 258 can read the control information and presentation time stamp information associated with video packets in the received data and output a frame number signal 263 which can be supplied to the controller 267. The controller 267 can supervise the counted number of frames at a predetermined interval. By way of a non-limiting example, the controller 267 can supervise the counted number of frames each time the decoding unit 260 completes a decoding operation.

In some embodiments, when the frame number signal 263 indicates that the receiver buffer 259 is at a predetermined capacity, the controller 267 can output a decoding start signal 264 to the decoding unit 260. When the frame number signal 263 indicates that the receiver buffer 259 is at less than a predetermined capacity, the controller 267 can wait for the occurrence of a situation in which the counted number of frames becomes equal to the predetermined amount. The controller 267 can output the decoding start signal 264 when the situation occurs. By way of a non-limiting example, the controller 267 can output the decoding start signal 264 when the frame number signal 263 indicates that the receiver buffer 259 is at the predetermined capacity. The encoded video packets and video compression data can be decoded in a monotonic order (i.e., increasing or decreasing) based on presentation time stamps associated with the encoded video packets.

In response to the decoding start signal 264, the decoding unit 260 can decode data amounting to one picture associated with a frame and compressed video data associated with the picture associated with video packets from the receiver buffer 259. The decoding unit 260 can write a decoded video signal 162 into the frame memory 261. The frame memory 261 can have a first area into which the decoded video signal is written and a second area used for reading out decoded pictures 262 to the output interface 267.

In various embodiments, the coding system 240 can be incorporated or otherwise associated with a transcoder or an encoding apparatus at a headend, and the decoding system 258 can be incorporated or otherwise associated with a downstream device, such as a mobile device, a set-top box, or a transcoder.

As described above, the encoders 202 employ compression algorithms to generate bit streams or files of smaller size than the original video sequences in the AV information 102. Such compression is made possible by reducing spatial and temporal redundancies in the original sequences.

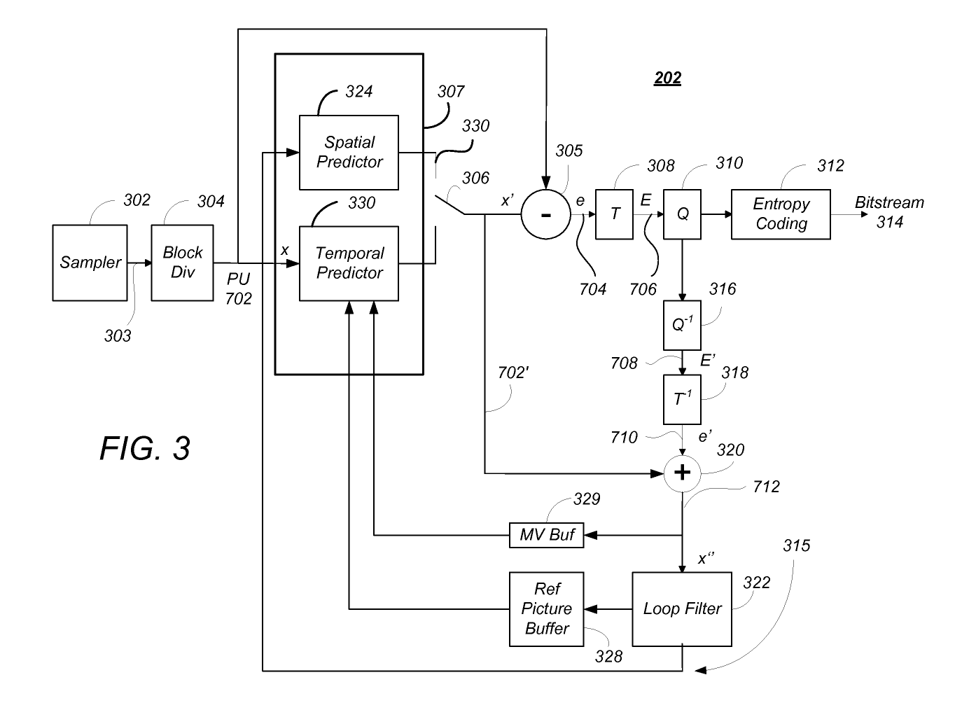

FIG. 3 is a block diagram illustrating one embodiment of the source encoder 202. The source encoder 202 accepts AV information 102 and uses sampler 302 to sample the AV information 102 to produce a sequence 303 of successive of digital images or pictures, each having a plurality of pixels. A picture can comprise a frame or a field, wherein a frame is a complete image captured during a known time interval, and a field is the set of odd-numbered or even-numbered scanning lines composing a partial image.

The sampler 302 produces an uncompressed picture sequence 303. Each digital picture can be represented by one or more matrices having a plurality of coefficients that represent information about the pixels that together compose the picture. The value of a pixel can correspond to luminance or other information. In the case where several components are associated with each pixel (for example red-green-blue components or luminance-chrominance components), each of these components may be separately processed.

Images can be segmented into “slices,” which may comprise a portion of the picture or may comprise the entire picture. In the H.264 standard, these slices are divided into coding entities called macroblocks (generally blocks of size 16 pixels×16 pixels), and each macroblock may in turn be divided into different sizes of data blocks, for example 4×4, 4×8, 8×4, 8×8, 8×16, or 16×8. HEVC expands and generalizes the notion of the coding entity beyond that of the macroblock.

Like other video coding standards, HEVC is a block-based hybrid spatial and temporal predictive coding scheme. However, HEVC introduces new coding entities that are not included with the H.264/AVC standard. These coding entities include Coding-Tree block (“CTUs”), coding units (“CUs”), predictive units (“PUs”), and transform units (“TUs”) which are further described below.

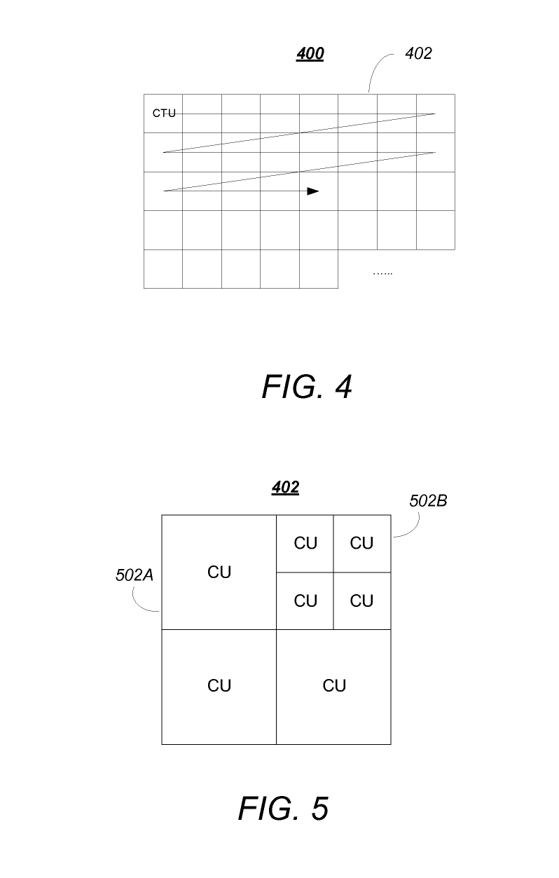

FIG. 4 is a diagram 400 of AV information 102, such as one of the pictures in the picture sequence 303. The picture 400 is spatially divided into non-overlapping square blocks known as CTUs 402. Unlike H.264 and previous video coding standards where the basic coding unit is macroblock of 16×16 pixels, the CTU 402 is the basic coding unit of HEVC and can be as large as 128×128 pixels. As shown in FIG. 4, the CTUs 402 are typically referenced within the picture 400 in an order analogous to a progressive scan.

Each CTU 402 may in turn be iteratively divided into smaller variable size coding units described by a “quadtree” decomposition further described below. Coding units are regions formed in the image to which similar encoding parameters are applied and transmitted in the bitstream 314.

FIG. 5 is a diagram showing an exemplary partition of a CTU 402 into CUs such as CUs 502A and 502B. A single CTU 402 can be divided into four CUs 502 such as CU 502A, each a quarter of the size of CTU 402. Each such divided CU 502A can be further divided into four smaller CUs 502B of a quarter of the size of the initial CU 502A.

The division of CTUs 402 into CUs 502A and into smaller CUs 502B is described by “quadtree” data parameters (e.g., flags or bits) that are encoded into the output bitstream 314 along with the encoded data as overhead called “syntax elements.”

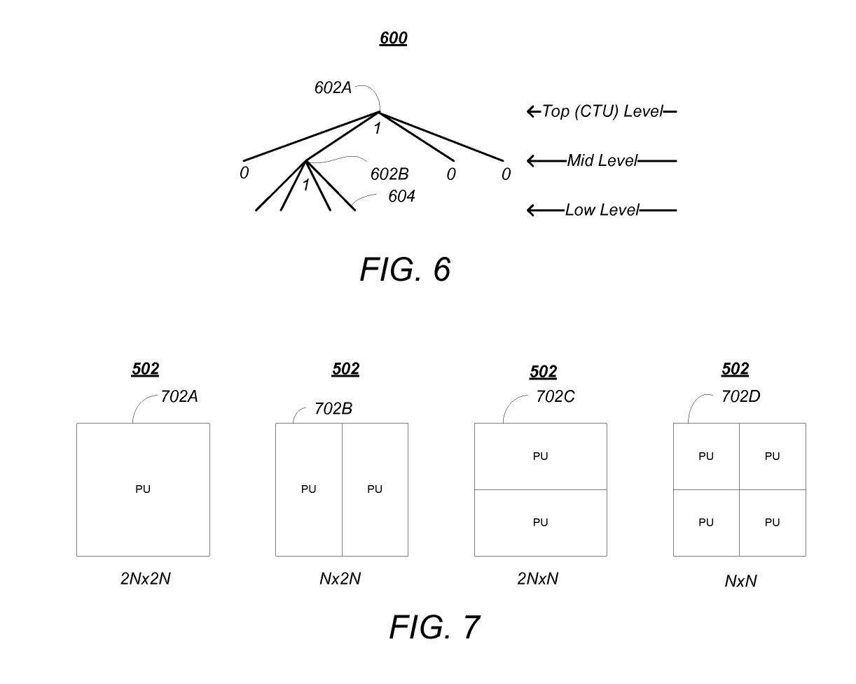

FIG. 6 is a diagram illustrating a representative quadtree 600 and data parameters for the CTU 402 partitioning shown in FIG. 5. The quadtree 600 comprises a plurality of nodes including first node 602A at one hierarchical level and second node 602B at a lower hierarchical level (hereinafter, quadtree nodes may be alternatively referred to as “nodes” 602). At each node 602 of a quadtree, a “split flag” or bit “1” is assigned if the node 602 is further split into sub-nodes, otherwise a bit “0” is assigned.

For example, the CTU 402 partition illustrated in FIG. 5 can be represented by the quadtree 600 presented in FIG. 6, which includes a split flag of “1” associated with node 602A at the top CU 502 level (indicating there are 4 additional nodes at a lower hierarchical level). The illustrated quadtree 600 also includes a split flag of “1” associated with node 602B at the middle CU 502 level to indicate that this CU is also partitioned into four further CUs 502 at the next (bottom) CU level. The source encoder 202 may restrict the minimum and maximum CU 502 sizes, thus changing the maximum possible depth of CU 502 splitting.

The encoder 202 generates encoded AV information 106 in the form of a bitstream 314 that includes a first portion having encoded data for the CUs 502 and a second portion that includes overhead known as syntax elements. The encoded data include data corresponding to the encoded CUs 502 (i.e., the encoded residuals together with their associated motion vectors, predictors, or related residuals as described further below). The second portion includes syntax elements that may represent encoding parameters which do not directly correspond to the encoded data of the blocks. For example, the syntax elements may comprise an address and identification of the CU 502 in the image, a quantization parameter, an indication of the elected Inter/Intra coding mode, the quadtree 600, or other information.

CUs 502 correspond to elementary coding elements and include two related sub-units: PUs and TUs, both of which have a maximum size equal to the size of the corresponding CU 502.

FIG. 7 is a diagram illustrating the partition of a CU 502 into one or more PUs 702. A PU 702 corresponds to a partitioned CU 502 and is used to predict pixels values for intra-picture or inter-picture types. PUs 702 are an extension of the partitioning of H.264/AVC for motion estimation and are defined for each CU 502 that is not further subdivided into other CUs (“split flag”=0). At each leaf 604 of the quadtree 600, a final (bottom level) CU 502 of 2N×2N can possess one of four possible patterns of PUs: 2N×2N (702A), N×2N (702B), 2N×N (702C), and N×N (702D), as shown in FIG. 7.

A CU 502 can be either spatially or temporally predictively encoded. If a CU 502 is coded in “intra” mode, each PU 702 of the CU 502 can have its own spatial prediction direction and image information as further described below. Also, in the “intra” mode, the PU 702 of the CU 502 may depend on another CU 502 because it may use a spatial neighbor, which is in another CU. If a CU 502 is coded in “inter” mode, each PU 702 of the CU 502 can have its own motion vectors and associated reference pictures as further described below.

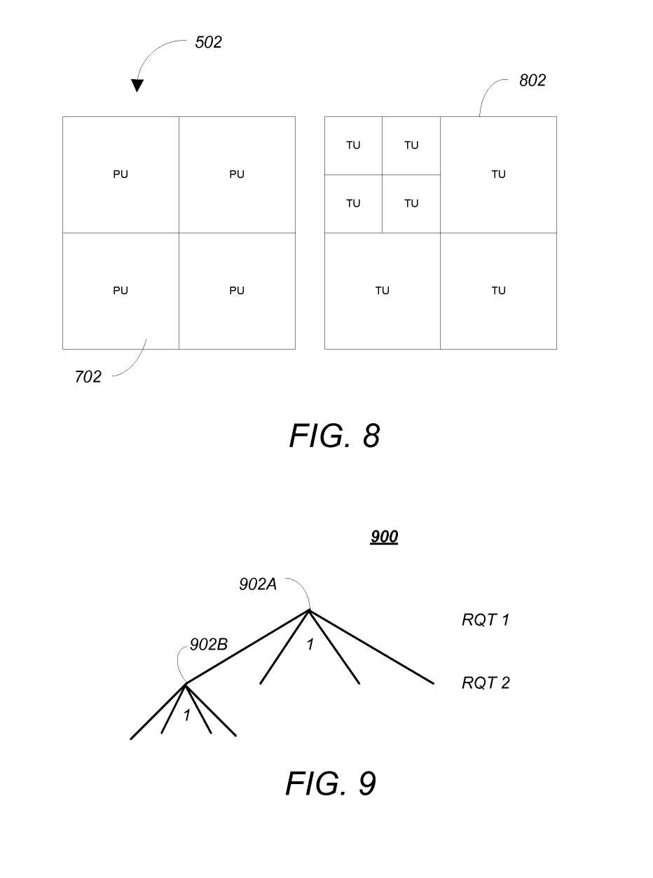

FIG. 8 is a diagram showing a CU 502 partitioned into four PUs 702 and an associated set of TUs 802. TUs 802 are used to represent the elementary units that are spatially transformed by a Discrete Cosine Transform (“DCT”). The size and location of each block transform TU 802 within a CU 502 is described by an RQT further illustrated below.

FIG. 9 shows RQT 900 for TUs 802 for the CU 502 in the example of FIG. 8. Note that the “1” at the first node 902A of the RQT 900 indicates that there are four branches, and that the “1” at the second node 902B at the adjacent lower hierarchical level indicates that the indicated node further has four branches. The data describing the RQT 900 are also coded and transmitted as overhead in the bitstream 314.

The coding parameters of a video sequence may be stored in dedicated NAL units called parameter sets. Two types of parameter sets may be employed. The first parameter set type is known as an SPS and comprises a NAL unit that includes parameters that are unchanged during the entire video sequence. Typically, an SPS handles the coding profile, the size of the video frames, and other parameters. The second type of parameter set is known as a PPS and codes different values that may change from one image to another.

One of the techniques used to compress a bitstream 314 is to forego the storage of pixel values themselves and instead predict the pixel values using a process that can be repeated at the decoder 220 and store or transmit the difference between the predicted pixel values and the actual pixel values (known as the residual). So long as the decoder 220 can compute the same predicted pixel values from the information provided, the actual picture values can be recovered by adding the residuals to the predicted values. The same technique can be used to compress other data as well.

Referring back to FIG. 3, each PU 702 of the CU 502 being processed is provided to a predictor module 307. The predictor module 307 predicts the values of the PUs 702 based on information in nearby PUs 702 in the same frame (intra-frame prediction, which is performed by the spatial predictor 324) and information of PUs 702 in temporally proximate frames (inter-frame prediction, which is performed by the temporal predictor 330). Temporal prediction, however, may not always be based on a collocated PU, since collocated PUs are defined to be located at a reference/non-reference frame having the same x and y coordinates as the current PU 702. These techniques take advantage of spatial and temporal dependencies between PUs 702.

Encoded units can therefore be categorized to include two types: (1) non-temporally predicted units and (2) temporally predicted units. Non-temporally predicted units are predicted using the current frame, including adjacent or nearby PUs 702 within the frame (e.g., intra-frame prediction), and are generated by the spatial predictor 324. Temporally predicted units are predicted from one temporal picture (e.g., P-frames) or predicted from at least two reference pictures temporally ahead or behind (i.e., B-frames).

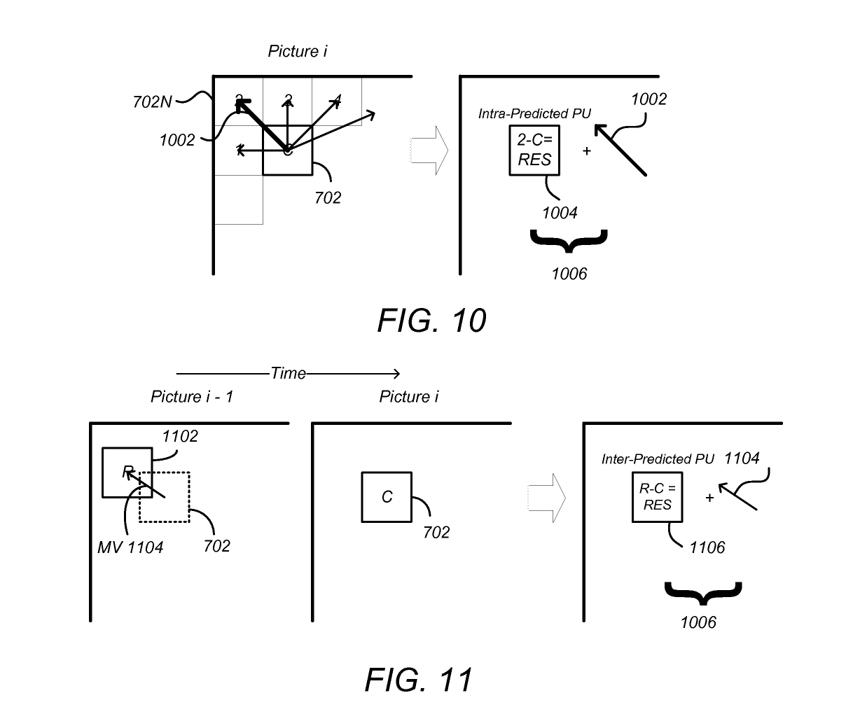

FIG. 10 is a diagram illustrating spatial prediction of PUs 702. A picture i may comprise a PU 702 and spatially proximate other PUs 1-4, including nearby PU 702N. The spatial predictor 324 predicts the current block (e.g., block C of FIG. 10) by means of an “intra-frame” prediction which uses PUs 702 of already encoded other blocks of pixels of the current image.

The spatial predictor 324 locates a nearby PU (e.g., PU 1, 2, 3, or 4 of FIG. 10) that is appropriate for spatial coding and determines an angular prediction direction to that nearby PU. In HEVC, 35 directions can be considered, so each PU may have one of 35 directions associated with it, including horizontal, vertical, 45 degree diagonal, 135 degree diagonal, DC, etc. The spatial prediction direction of the PU is indicated in the syntax.

Referring back to the spatial predictor 324 of FIG. 3, this located nearby PU is used to compute a residual PU 704 (e) as the difference between the pixels of the nearby PU 702N and the current PU 702, using element 305. The result is an intra-predicted PU element 1006 that comprises a prediction direction 1002 and the intra-predicted residual PU 1004. The prediction direction 1002 may be coded by inferring the direction from spatially proximate PUs and the spatial dependencies of the picture, enabling the coding rate of the intra prediction direction mode to be reduced.

FIG. 11 is a diagram illustrating temporal prediction. Temporal prediction considers information from temporally neighboring pictures or frames, such as the previous picture, picture i-1.

Generally, temporal prediction includes single-prediction (P-type), which predicts the PU 702 by referring to one reference area from only one reference picture, and multiple prediction (B-type), which predicts the PU by referring to two reference areas from one or two reference pictures. Reference images are images in the video sequence that have already been coded and then reconstructed (by decoding).

The temporal predictor 330 identifies, in one or several of these reference areas (one for P-type or several for B-type), areas of pixels in a temporally nearby frame so that they can be used as predictors of this current PU 702. In the case where several areas predictors are used (B-type), they may be merged to generate one single prediction. The reference area 1102 is identified in the reference frame by a motion vector (“MV”) 1104 that defines the displacement between the current PU 702 in current frame (picture i) and the reference area 1102 (“refIdx”) in the reference frame (picture i-1). A PU in a B-picture may have up to two MVs. Both MV and refIdx information are included in the syntax of the HEVC bitstream.

Referring again to FIG. 3, a difference between the pixel values of the reference area 1102 and the current PU 702 may be computed by element 305 as selected by switch 306. This difference is referred to as the residual of the inter-predicted PU 1106. At the end of the temporal or inter-frame prediction process, the current PU 1006 is composed of one MV 1104 and a residual 1106.

However, as described above, one technique for compressing data is to generate predicted values for the data using means repeatable by the decoder 220, computing the difference between the predicted and actual values of the data (the residual) and transmitting the residual for decoding. So long as the decoder 220 can reproduce the predicted values, the residual values can be used to determine the actual values.

This technique can be applied to the MVs 1104 used in temporal prediction by generating a prediction of the MV 1104, computing a difference between the actual MV 1104 and the predicted MV 1104 (a residual), and transmitting the MV residual in the bitstream 314. So long as the decoder 220 can reproduce the predicted MV 1104, the actual MV 1104 can be computed from the residual. HEVC computes a predicted MV for each PU 702 using the spatial correlation of movement between nearby PUs 702.

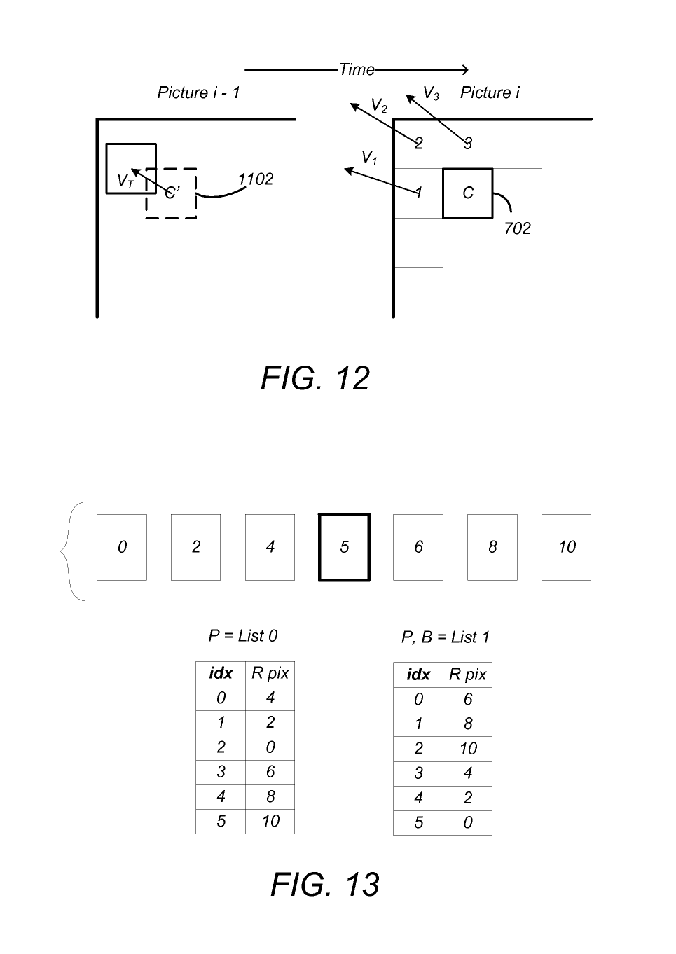

FIG. 12 is a diagram illustrating the use of MVPs in HEVC. MVPs V₁, V₂, and V₃ are taken from the MVs 1104 of a plurality of blocks 1, 2, and 3 situated nearby or adjacent to the block to encode (C). As these vectors refer to MVs of spatially neighboring blocks within the same temporal frame and can be used to predict the MV of the block to encode, these vectors are known as spatial motion predictors.

FIG. 12 also illustrates a temporal MVP V_{T} which is the MV of the co-located block C′ in a previously decoded picture (in decoding order) of the sequence (e.g., a block of picture i-1 located at the same spatial position as the block currently being coded (block C of image i)).

The components of the spatial MVPs V₁, V₂, and V₃ and the temporal MVP V_{T} can be used to generate a median MVP V_{M}. In HEVC, the three spatial MVPs may be taken as shown in FIG. 12, that is, from the block situated to the left of the block to encode (V₁), the block situated above (V₃), and from one of the blocks situated at the corners of the block to encode (V₂), according to a predetermined rule of availability. This MV predictor selection technique is known as Advanced Motion Vector Prediction.

A plurality of (typically five) MVP candidates having spatial predictors (e.g., V₁, V₂, and V₃) and temporal predictors V_{T} are therefore obtained. In order to reduce the overhead of signaling the MVP in the bitstream, the set of MVPs may be reduced by eliminating data for duplicated MVs (for example, MVs which have the same value as other MVs may be eliminated from the candidates).

The encoder 202 may select a “best” MVP from among the candidates, compute an MVP residual as a difference between the selected MVP and the actual MV, and transmit the MVP residual in the bitstream 314. To perform this operation, the actual MV must be stored for later use by the decoder 220 (although it is not transmitted in the bit stream 314). Signaling bits or flags are included in the bitstream 314 to specify which MV residual was computed from the normalized MVP and are later used by the decoder to recover the MV. These bits or flags are further described below.

Referring back to FIG. 3, the intra-predicted residuals 1004 and the inter-predicted residuals 1106 obtained from the spatial (intra) or temporal (inter) prediction process are then transformed by transform module 308 into the TUs 802 described above. A TU 802 can be further split into smaller TUs using the RQT decomposition described above with respect to FIG. 9. In HEVC, generally two or three levels of decomposition are used and authorized transform sizes are 32×32, 16×16, 8×8, and 4×4. As described above, the transform is derived according to a DCT or discrete sine transform.

The residual transformed coefficients are then quantized by quantizer 310. Quantization plays a very important role in data compression. In HEVC, quantization converts the high precision transform coefficients into a finite number of possible values. Although the quantization permits a great deal of compression, quantization is a lossy operation, and the loss by quantization cannot be recovered.

The coefficients of the quantized transformed residual are coded by means of an entropy coder 312 and then inserted into the compressed bit stream 314 as a part of the useful data coding the images of the AV information. Coding syntax elements may also be coded using spatial dependencies between syntax elements to increase the coding efficiency. HEVC offers context-adaptive binary arithmetic coding (“CABAC”). Other forms of entropy or arithmetic coding may also be used.

In order to calculate the predictors used above, the encoder 202 decodes already encoded PUs 702 using the “decoding” loop 315, which includes elements 316, 318, 320, 322, and 328. This decoding loop 315 reconstructs the PUs and images from the quantized transformed residuals.

The quantized transform residual coefficients E are provided to dequantizer 316, which applies the inverse operation to that of quantizer 310 to produce dequantized transform coefficients of the residual PU (E′) 708. The dequantized data 708 are then provided to inverse transformer 318 which applies the inverse of the transform applied by the transform module 308 to generate reconstructed residual coefficients of the PU (e′) 710.

The reconstructed coefficients of the residual PU 710 are then added to the corresponding coefficients of the corresponding predicted PU (x′) 702′ selected from the intra-predicted PU 1004 and the inter-predicted PU 1106 by selector 306. For example, if the reconstructed residual comes from the “intra” coding process of the spatial predictor 324, then the “intra” predictor (x′) is added to this residual in order to recover a reconstructed PU (x″) 712 corresponding to the original PU 702 modified by the losses resulting from a transformation, for example in this case the quantization operations. If the residual 710 comes from an “inter” coding process of the temporal predictor 330, then the areas pointed to by the current MVs (these areas belong to the reference images stored in reference buffer 328 referred by the current image indices) are merged and then added to this decoded residual. In this way the original PU 702 is modified by the losses resulting from the quantization operations.

To the extent that the encoder 202 uses motion vector prediction techniques analogous to the image prediction techniques described above, the MV may be stored using the MV buffer 329 for use in temporally subsequent frames. As further described below, a flag may be set and transferred in the syntax to indicate that the MV for the currently decoded frame should be used for at least the subsequently coded frame instead of replacing the contents of the MV buffer 329 with the MV for the current frame.

A loop filter 322 is applied to the reconstructed signal (x″) 712 in order to reduce the effects created by heavy quantization of the residuals obtained and to improve the signal quality. The loop filter 322 may comprise, for example, a deblocking filter for smoothing borders between PUs to visually attenuate high frequencies created by the coding process and a linear filter that is applied after all of the PUs for an image have been decoded to minimize the sum of the square difference (“SSD”) with the original image. The linear filtering process is performed on a frame-by-frame basis and uses several pixels around the pixel to be filtered and also uses spatial dependencies between pixels of the frame. The linear filter coefficients may be coded and transmitted in one header of the bitstream, typically a picture or slice header.

The filtered images, also known as reconstructed images, are then stored as reference images in reference image buffer 328 in order to allow the subsequent “Inter” predictions taking place during the compression of the subsequent images of the current video sequence.

As described above, to reduce errors and to improve compression, HEVC permits the use of several reference images for estimation and motion compensation of the current image. Given a current PU 702 in a current picture, the collocated PU 1102 for a particular slice resides in an associated nearby reference or non-reference picture. For example, in FIG. 12, the collocated PU 1102 for the current PU 702 in picture (i) resides in the associated nearby reference picture (i-1). The best “inter” or temporal predictors of the current PU 702 are selected in some of the multiple reference or non-reference images, which may be based on pictures temporally prior to or after the current picture in display order (backwards and forward prediction, respectively).

For HEVC, the index to reference pictures is defined by reference picture lists that are described in the slice syntax. Forward prediction is defined by list_{—}0 (“RefPicList0”), and backward prediction is defined by list_{—}1 (“RefPicList1”), and both list 0 and list 1 can contain multiple reference pictures prior to or later than the current picture in the display order.

FIG. 13 illustrates an example of the use of the reference picture lists. Consider pictures 0, 2, 4, 5, 6, 8, and 10 shown in FIG. 13, wherein the numbers of each picture denote display order, and the current picture is picture 5. In this case, the list_{—}0 reference pictures with ascending reference picture indices and starting with index equal to zero are 4, 2, 0, 6, 8, and 10, and the list_{—}1 reference pictures with ascending reference picture indices and starting with index equal to zero are 6, 8, 10, 4, 2, and 0. A slice that the motion compensated prediction is restricted to the list_{—}0 prediction is called a predictive or P-slice. Collocated pictures are indicated by using the collocated_ref_idx index in the HEVC. A slice for which the motion-compensated prediction includes more than one reference picture is a bi-predictive or B-slice. For B-slices, the motion compensated prediction may include reference pictures from list_{—}1 prediction as well as list_{—}0.

Hence, a collocated PU 1102 is disposed in a reference picture specified in either list_{—}0 or list_{—}1. A flag (collocated_from_{—}10_flag) is used to specify whether the collocated partition should be derived from list_{—}0 or list_{—}1 for a particular slice type. Each of the reference pictures is also associated with an MV.

According to the HEVC standard, if the slice_type is equal to B, and the collocated_from_{—}10_flag is 0, then the collocated_ref_idx variable specifies the reference picture as the picture that contains the co-located partition as specified by RefPicList1. Otherwise (slice_type is equal to B and collocated_from_{—}10_flag is equal to 1 or slice_type is equal to P), the collocated_ref_idx variable specifies the reference picture as the picture that contains the collocated partition as specified by RefPicList0.

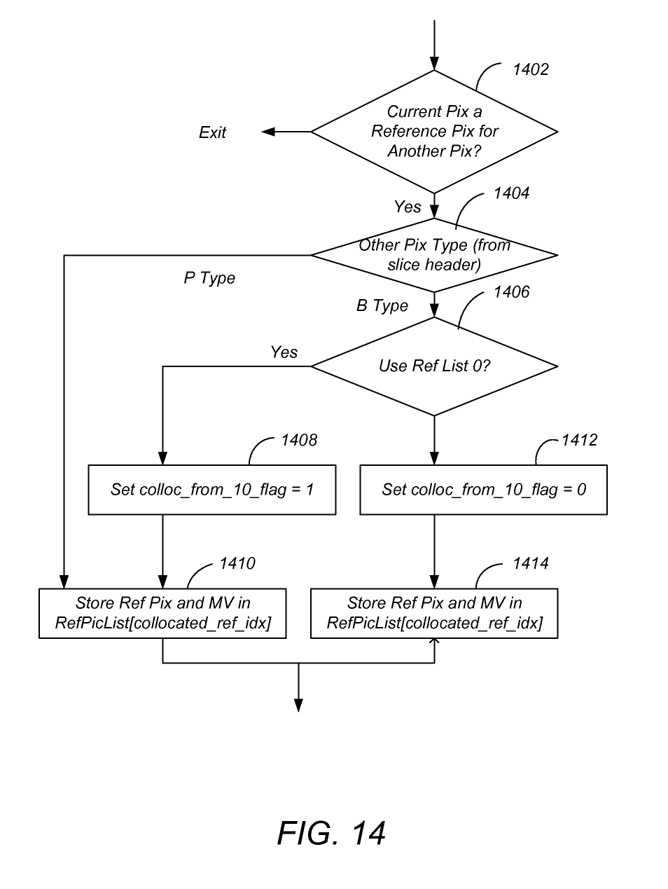

FIG. 14 is a diagram illustrating processes performed by the encoder 202 according to the aforementioned standard. Block 1402 determines whether the current picture is a reference picture for another picture. If not, there is no need to store the reference picture or MV information. If the current picture is a reference picture for another picture, then block 1504 determines whether the “another” picture is a P-type or a B-type picture. If the picture is a P-type picture, then processing is passed to block 1410, which sets the collocated_from_{—}10_flag to one and stores the reference picture and MV in list 0. If the “another picture” is a B-type picture, then block 1406 nonetheless directs processing to blocks 1408 and 1410 if the desired reference picture is to be stored in list 0, and to blocks 1412 and 1414 if the desired reference picture and MV are to be stored in list 1. This decision may be based on whether it is desirable to select reference pictures from a temporally preceding or succeeding picture. Which of the multiple possible reference pictures is selected is determined according to the collocated_ref_idx index.

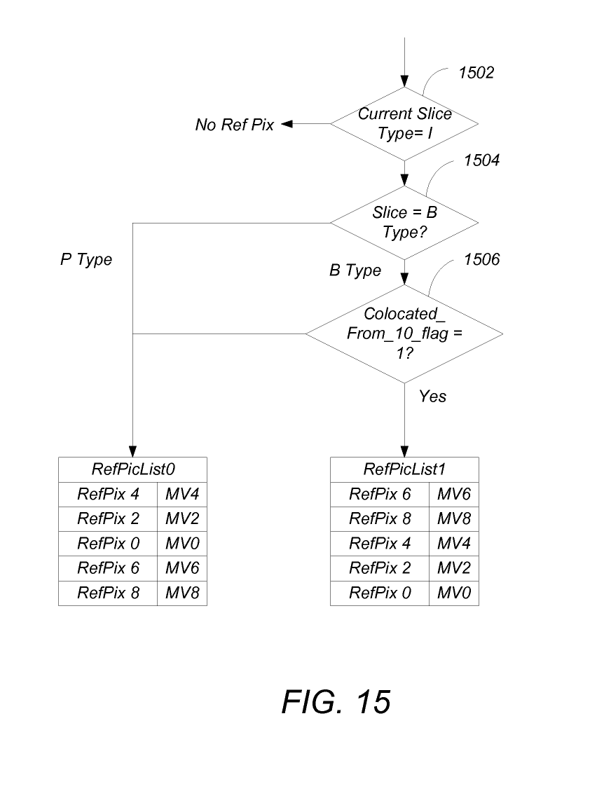

FIG. 15 depicts the use of a the collocated_from_{—}10_flag by the decoder 220 in decoding according to the previous HEVC standard. Block 1502 determines if the current slice type being computed is an intra or I-type. Such slices do not use temporally nearby slices in the encoding/decoding process, and hence there is no need to find a temporally nearby reference picture. If the slice type is not I-type, then block 1504 determines whether the slice is a B-slice. If the slice is not a B-type, it is a P-type slice, and the reference picture that contains the collocated partition is found in list 0, according to the value of collocated_ref_idx. If the slice is B-type, then the collocated_from_{—}10_flag determines whether the reference picture is found in list 0 or list 1. As the index indicates, the collocated picture is therefore defined as the reference picture having the indicated collocated_ref_idx in either list 0 or list 1, depending on the slice type (B-type or P-type) and the value of the collocated_from_{—}10_flag. In one embodiment of HEVC, the first reference picture (the reference picture having index [0] as shown in FIG. 13) is selected as the collocated picture.

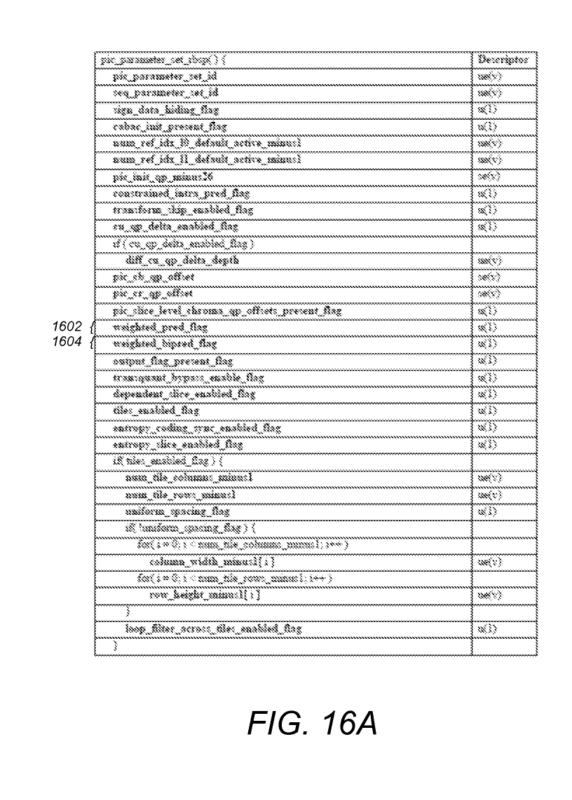

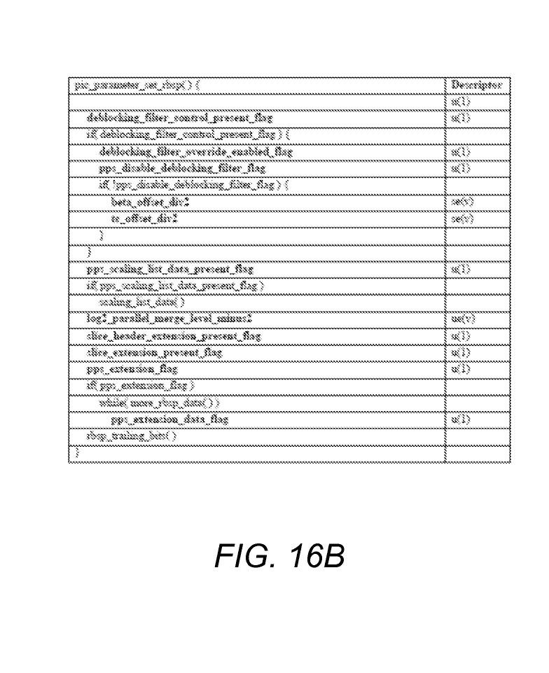

FIGS. 16A and 16B are diagrams presenting a baseline PPS syntax.

HEVC implements a technique known as weighted prediction, which is used to encode chroma and luma data used in slices subject to temporal encoding. As described, weighted prediction can consider one other reference slice (uni-weighted prediction) or two or more slices (bi-weighted prediction). As illustrated in FIG. 16A, the PPS syntax includes two flags related to weighted prediction operations: weighted_pred_flag 1602 and weighted_bipred_flag 1604. The weighted prediction flag 1602 specifies whether weighted prediction is to be applied to image data of P-slices. Setting the value to logical 1 indicates that weighed prediction is to be applied to image data in the P-slices in the picture, whereas setting the value to logical 0 indicates that weighted prediction is not to be applied to P-slices within the picture. Similarly, the weighted_bipred_flag 1604 is set to logical 0 to specify that the default weighted prediction is applied to B slices, and set to logical 1 specifies that weighted prediction is applied to B slices.

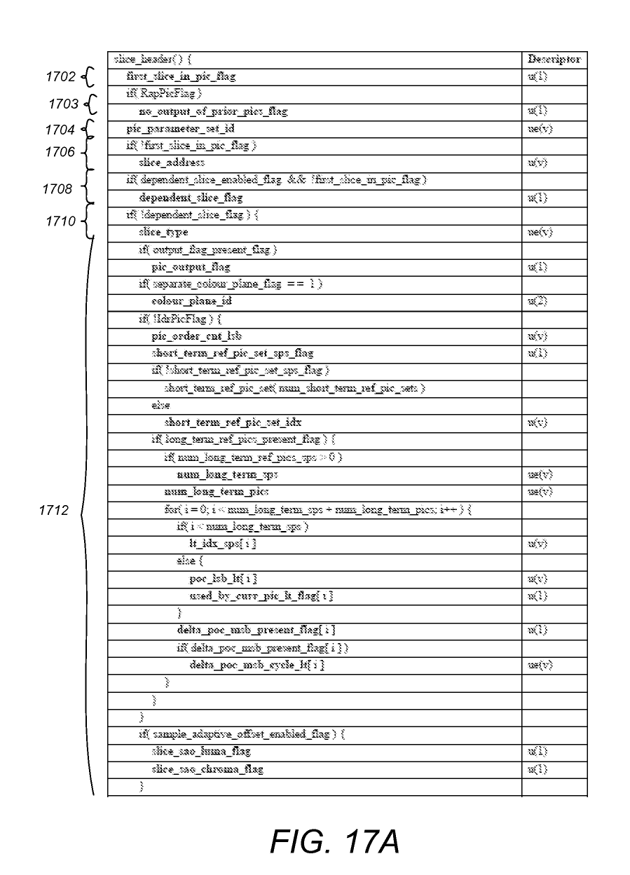

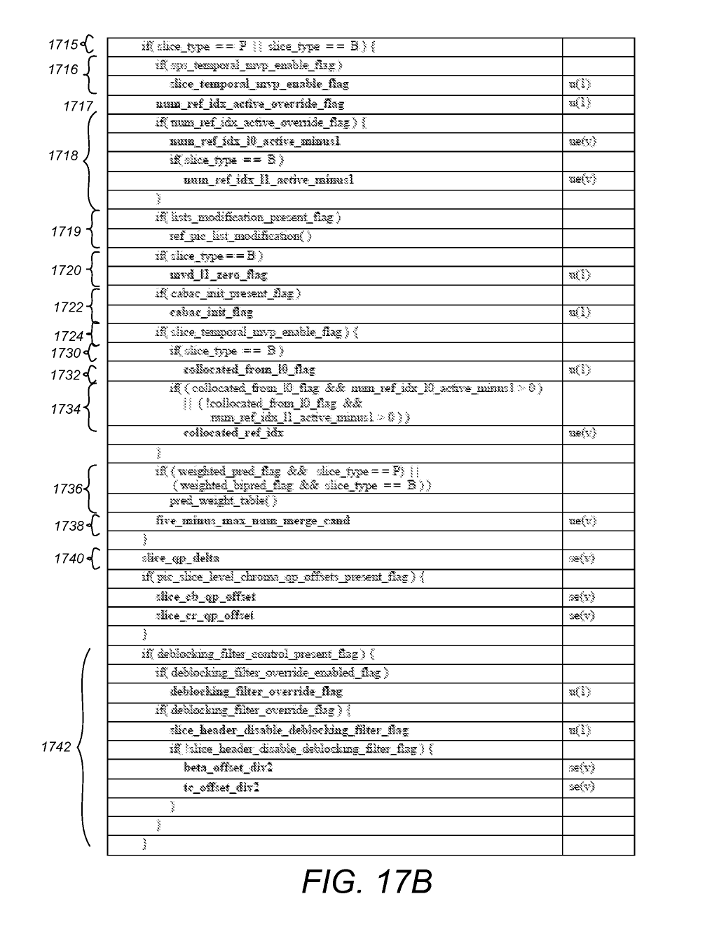

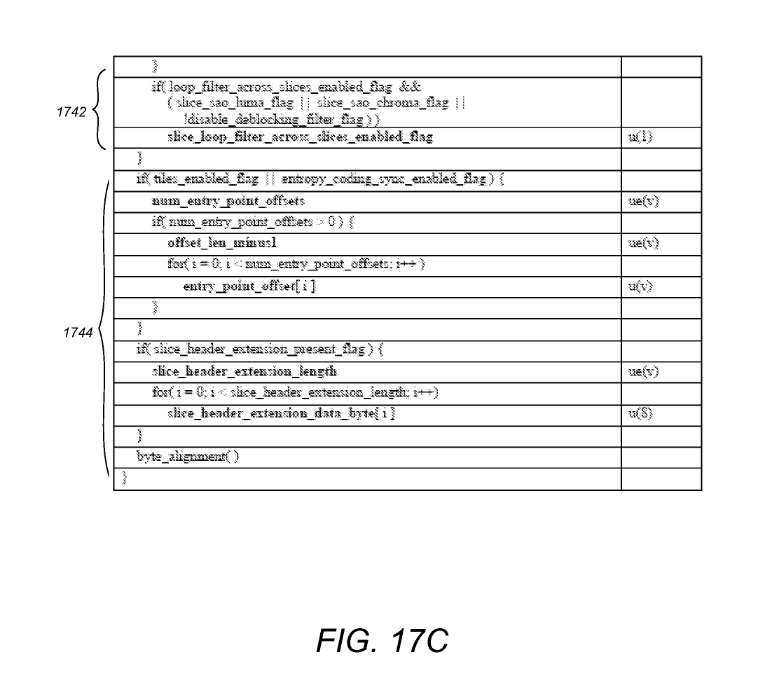

FIGS. 17A through 17C are diagrams presenting a baseline slice header logic and syntax. In the diagrams, indentation of the text indicates the logical structure of the syntax, wherein the delimiter “∥” represents a logical “OR,” “&&” represents a logical “AND,” and “!” represents a logical inverse or complement. Further, if a logical condition statement (e.g., “if” statement) is true, then the operations indented from the logical if statement (and enclosed in brackets “{ }”) are performed, otherwise processing continues to the next logical statement.

Turning first to FIG. 17A, slice processing syntax differs depending upon whether the slice is the first of a plurality of slices in a picture, or if it is not the first slice in the picture. Accordingly, the slice header comprises a first slice in picture flag (first_slice_in_pic_flag) that is read. This is illustrated in syntax 1702. If a RapPicFlag is set, a no_output_of_prior_pics_flag is read, as shown in syntax 1703.

As described earlier, the HEVC standard includes a plurality of NAL unit types that include a VPS, an SPS which presents parameters for a sequence of pictures, and a PPS which describes parameters for a particular picture. An identifier of the picture parameter set is also read. If the slice is not the first slice in the picture, then the slice address is read. This is illustrated in syntax 1706.

As described above, slices may include non-dependent slices or dependent slices, and the slice header syntax permits the disabling or enabling of the use of dependent slices altogether. The next logic uses a previously read flag that signals that dependent slices are enabled and the first_slice_in_pic_flag to determine whether to read the dependent_slice_flag. Note that if the slice is the first slice in the picture, then the dependent_slice_flag for this slice is not read, as the slice cannot be a dependent slice under such circumstances. If the slice is not a dependent slice, then the logic that follows reads the slice type and other parameters that are used in later processing for all slice types (I, P, and B). Further processing shown in syntax 1712 is also performed.

Turning now to FIG. 17B, syntax 1715 includes a conditional statement testing whether the slice_type data read earlier in the slice header indicate if the slice type is either P or B. If the slice type is neither P or B, then processing is routed to determine whether read reference picture list (ref_pic_list_modification) is read or not, as further discussed below with reference to syntax 1719. If the slice type is a P or B, then the logic uses an sps_temporal_mvp_enable_flag that was read as a part of the SPS header syntax to determine if the slice may be decoded using temporal MVP. If the flag is set, indicating that temporal MVP may be enabled, then a flag describing whether temporal MVP is permitted for the picture containing the slice is read.

Regardless of the status of the sps_temporal_mvp_enable_flag, the num_ref_idx_active_override_flag is read as shown in syntax 1717. This flag indicates whether a parameter (num_ref_inx_{—}10_active_minus1) describing the maximum reference picture list index for list_{—}0 (P-type) or another parameter (num_ref_idx_{—}11_active_minus1) describing the maximum reference picture list index for list_{—}1 (B-type) are present in the slice header. If the num_ref_idx_active_override_flag is positive, then the num_ref_inx_{—}10_active_minus1 parameter is read, and if the slice is a B-type slice, then the num_ref_inx_{—}11_active_minus1 parameter is also read, as shown in syntax 1718.

HEVC permits the baseline of the reference pictures to be modified in the encoding process. Without regard for the slice type (since the operations that follow are not within the conditional in syntax 1715 testing whether the slice is a P-type or a B-type), a previously read flag is read, in one embodiment, from the PPS. If this flag tests as a logic 1, then a ref_pic_list_modification syntax is executed.

This information is used by the ref_pic_list_modification syntax to read, based on the slice type, a flag identifying whether the slice was encoded according to an implicit reference picture list (if the flag is a logical zero or not provided) or if the reference picture list for the reference picture list associated with the slice is to be explicitly defined (if the flag is logical 1), in which case list entries for the reference picture list are read. As described further below, the baseline ref_pic_list_modification syntax includes logical conditional statements based on the slice-type, which are simplified in the solutions described below.

Next, the slice header logic again determines whether the slice under consideration is a B-type slice, and if so, reads an mvd_{—}11_zero_flag. The mvd_{—}11_zero_flag is not applicable to P-type slices and indicates whether the MV difference coding syntax structure used with B-type slices is parsed or not. This is shown in syntax 1720.

As described above with reference to the entropy encoder 312 illustrated in FIG. 3, HEVC implements context adaptive coding such as CABAC. CABAC is a form of entropy encoding that encodes binary symbols using probability models. A non-binary valued symbol (such as a transform unit coefficient or MV) is binarized or converted into a binary code prior to arithmetic coding. Stages are repeated for each bit (or “bin”) of the binarized symbol.

A context model is a probability model for one or more bins of the binarized symbol. This model may be chosen from a plurality of available models depending on the statistics of recently coded data symbols. The context model stores the probability of each bin being “1” or “0.” An arithmetic coder then encodes each bin according to the selected probability model.

A context variable is a variable specified for the adaptive binary arithmetic decoding process of a bin by an equation containing recently decoded bins. A cabac_init_flag specifies the method for determining the initialization table used in the initialization process for context variables. The value of cabac_init_flag is from 0 to 1, inclusive. When cabac_init_flag is not present, it is inferred to be 0.

Returning to FIG. 17B, the slice header logic checks a signaling flag indicating whether the cabac_init_flag is present in the slice header and should be read. If the signaling flag indicates that the context variable initialization flag is present in the slice header, then the context variable initialization flag is read. The context variable initialization variable flag specifies the method for determining the initialization table used in the context variable initialization process. This is shown in syntax 1722.

Next, the slice header logic performs operations related to determining the location of the collocated picture used for temporal MVP. The slice header first checks if temporal MVP is enabled on a slice/picture level by checking a flag as shown in syntax 1724. If the flag is not set, then processing is directed to the weighted prediction discussed further below. If the flag is set, then the slice header logic determines if the slice type is B, as shown in syntax 1730. If the slice type is B, then the slice header logic reads the collocated_from_{—}10_flag, as shown in syntax 1732. Next, the logic determines if the slice type is not I-type and either (1) the logical combination of the collocated_from_{—}10_flag and the num_ref_idx_{—}10_active_minus1 is greater than zero or (2) the logical combination of the inverse of the collocated_from_{—}10_flag and the num_ref_idx_active_minus1 is greater than zero. If either of these possibilities tests to True, then the collocated_ref_idx is read, as shown in syntax 1734.

HEVC and previous coding standards permit a scaling and offset operation that is applied to prediction signals in a manner known as weighted prediction. Whereas H.264/MPEG-4 AVC supported both temporally-implicit and explicit weighted prediction, in HEVC, only explicit weighted prediction is applied, by scaling and offsetting the prediction with values sent explicitly by the encoder. The bit depth of the prediction is then adjusted to the original bit depth of the reference samples. In the case of uni-prediction, the interpolated (and possibly weighted) prediction value is rounded, right-shifted, and clipped to have the original bit depth. In the case of bi-prediction, the interpolated (and possibly weighted) prediction values from two prediction blocks are added first, and then rounded, right-shifted and clipped.

In previous coding standards, up to three stages of rounding operations are required to obtain each prediction sample (for samples located at quarter-sample positions). Thus, if bi-prediction is used, then the total number of rounding operations is then seven in the worst case. In HEVC, at most two rounding operations are needed to obtain each sample located at the quarter-sample positions; thus five rounding operations are sufficient in the worst case when bi-prediction is used. Moreover, in the most common case, where the bit depth B is 8 bits, the total number of rounding operations in the worst case is further reduced to three. Due to the lower number of rounding operations, the accumulated rounding error is decreased, and greater flexibility is enabled in regard to the manner of performing the necessary operations in the decoder.

Returning to FIG. 17B, the slice header logic uses the slice type and the weighted prediction flags described above to determine if a table for weighted prediction is to be read and applied to the image data of the slice. As described above, the weighted_pred_flag is set equal to logical 0 to indicate that the weighted prediction is not applied to P slices, and set to logical 1 to indicate that weighted prediction is applied to P slices. The weighted_bipred_flag is set to logical 0 to specify that the default weighted prediction is applied to B slices, and set to logical 1 specifies that weighted prediction is applied to B slices. The slice header logic includes logic to read and apply the prediction weight table to slice image values if the weighted_pred_flag is set to a logical 1 and the slice type is P or if the weighted_bipred_flag is set to a logical 1 and the slice type is B, as shown in syntax 1736.

A maximum number of MV prediction candidates that are supported in the slice can be specified. In the slice header logic, this is specified as the difference between the number “5” and the maximum number and is referred to as five_minus_max_num_merge_cand. In the next slice header logic, if the slice type is a P type or a B type, then the five_minus_max_num_merge_cand is read, as shown in syntax 1738. Since the maximum number of candidates is typically five, the number read is typically zero.

Without regard for the outcome of the syntax 1715 determining if the slice was an inter-predicted (P or B type) slice, the slice header logic reads a variable describing the initial value for a quantization parameter to be used in coding blocks of data is read. This initial value is used until modified in the coding unit. This is illustrated by syntax 1740.

As described above, the loop filter 322 of the encoder/decoder may comprise, for example, a deblocking filter for smoothing borders between PUs to visually attenuate high frequencies created by the coding process and a linear filter that is applied after all of the PUs for an image have been decoded to minimize the SSD with the original image. The linear filtering process is performed on a frame-by-frame basis and uses several pixels around the pixel to be filtered and also uses spatial dependencies between pixels of the frame. The linear filter coefficients may be coded and transmitted in one header of the bitstream, typically a picture or slice header.

Returning to FIG. 17B, the slice header logic performs deblocking filter logic, as illustrated with respect to syntax 1742. This step is performed without regard for the outcome of the logic determining if the slice was an inter-predicted (P or B type) slice as described in syntax 1715 above. First, the slice header logic determines whether a deblocking filter control is enabled by checking the status of a control flag in the PPS. If the flag tests true, then logic checks to determine if the deblocking filter is overridden by checking another flag which indicates that the slice header for pictures referring to the PPS have a deblocking filter override. If this filter is enabled, then a flag is read that indicates that the deblocking filter is to be overridden. Logic then determines whether the deblocking override filter is set, and if so, reads a slice header level flag (that indicates whether the deblocking filter should be disabled). If this flag is not set, then the slice header logic reads the beta_offset_div 2 and tc_offset_div 2 data, which specify default deblocking parameter offsets.

Finally, HEVC permits in-loop filtering operations to be performed across left and upper boundaries of the current slice. Previous editions of the HEVC slice header included a flag that when set equal to 1 specifies that these in-loop filtering operations (include the deblocking filter and sample adaptive offset filter) are performed across the left and upper boundaries of the current slice; otherwise, the in-loop operations are not applied across left and upper boundaries of the current slice. The logic of syntax 1742 reads this flag if the feature is enabled on a sequence level (e.g., the loop_filter_across_slices_enabled_flag is set and any one of the indicated flags is set, as shown in syntax 1742). The remaining slice header syntax logic 1744 relates to the use of tiles or slice header extensions.

As described above, placing the flags controlling the reading and application of weighted prediction data to image data in the PPS creates logical inconsistencies and can result in wasted bits. Accordingly, this disclosure describes removing such flags from the PPS and instead using a single flag in the slice header to perform analogous functionality.

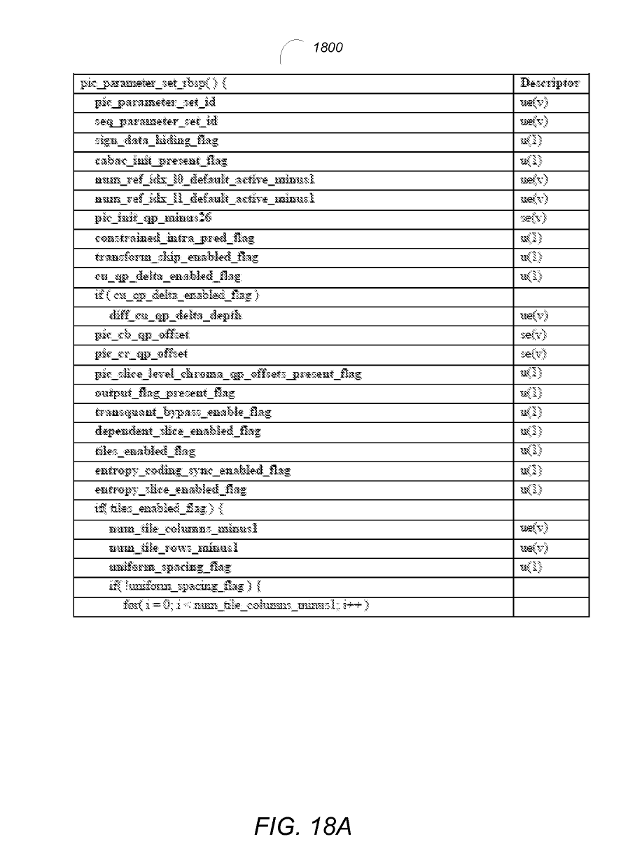

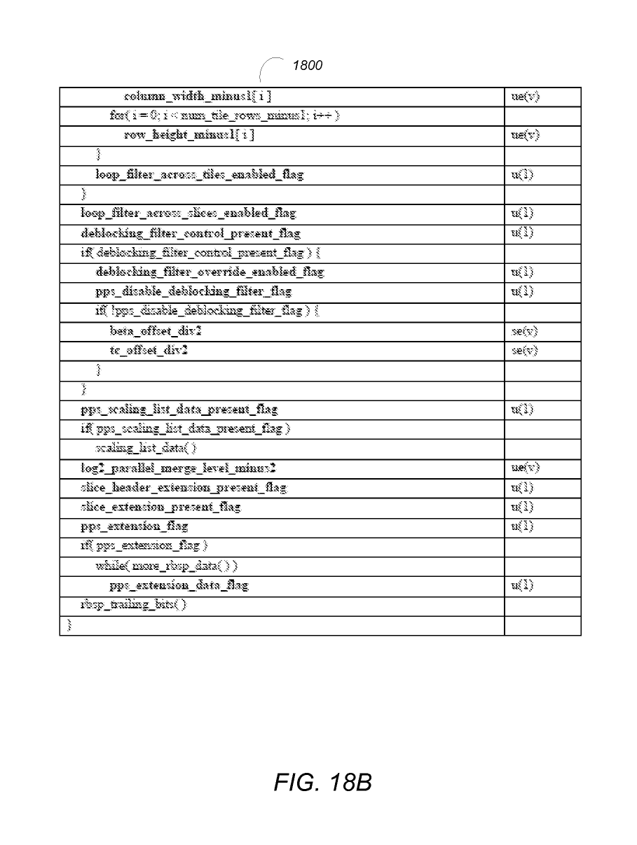

FIGS. 18A and 18B are diagrams illustrating one embodiment of an improved PPS syntax 1800. Importantly, the improved PPS syntax no longer includes the weighted_pred_flag 1602 and weighted_bipred_flag 1604 or any other flag related to weighted prediction processing on a picture level. Instead, flags controlling weighted prediction processing are disposed in the slice header, as described further below

As described above, the baseline slice header design includes logic that reads the weighted prediction table of data based upon syntax implementing a logical test to determine if the weighted_pred_flag is set and the slice in question is a P type slice or if the weighted_bipred_idc is set and the slice type is B.

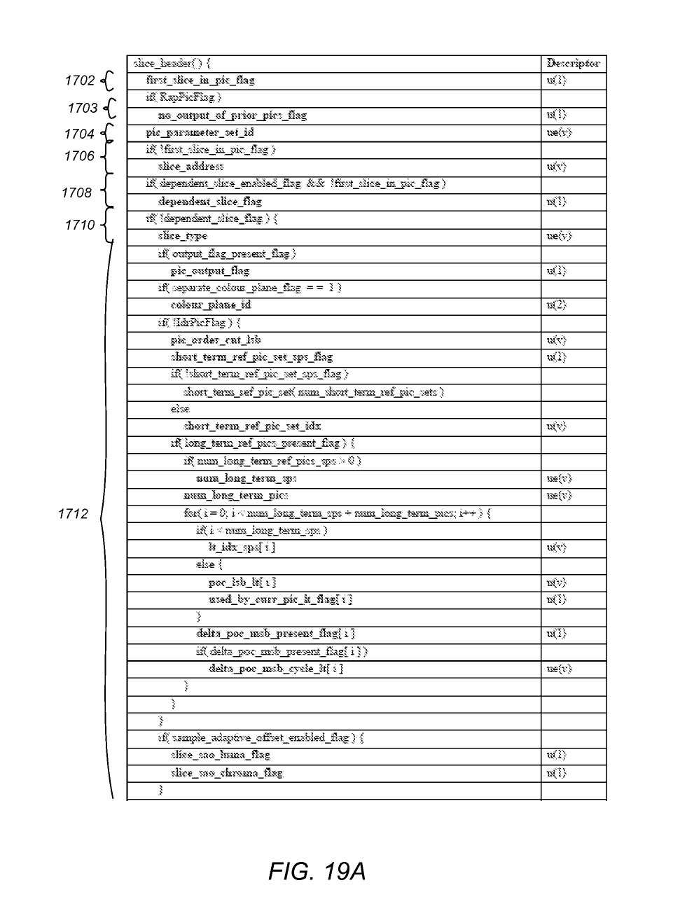

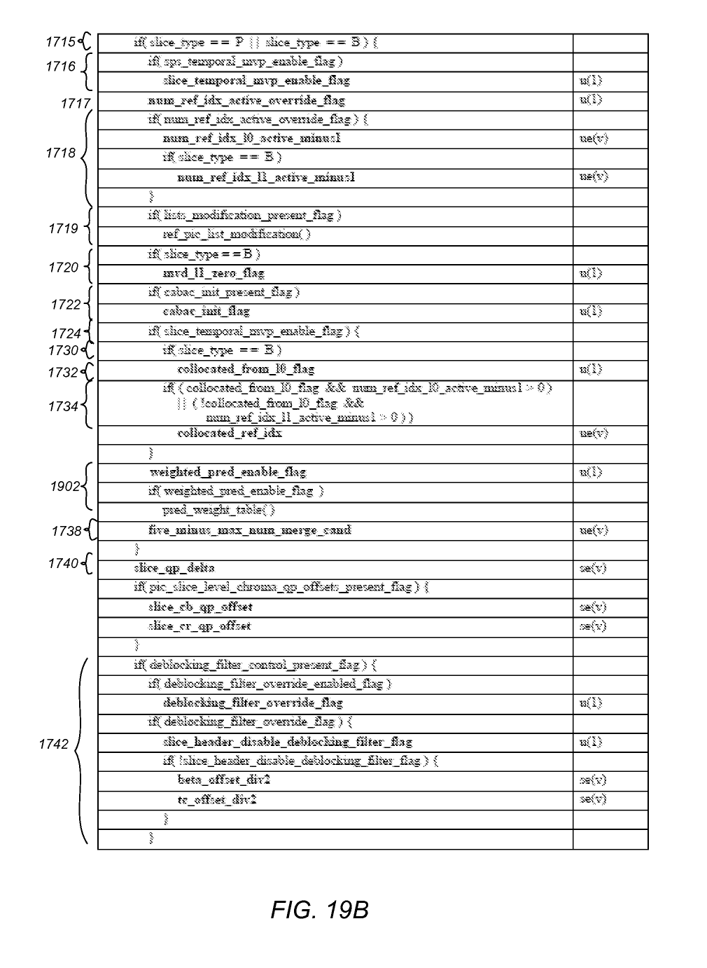

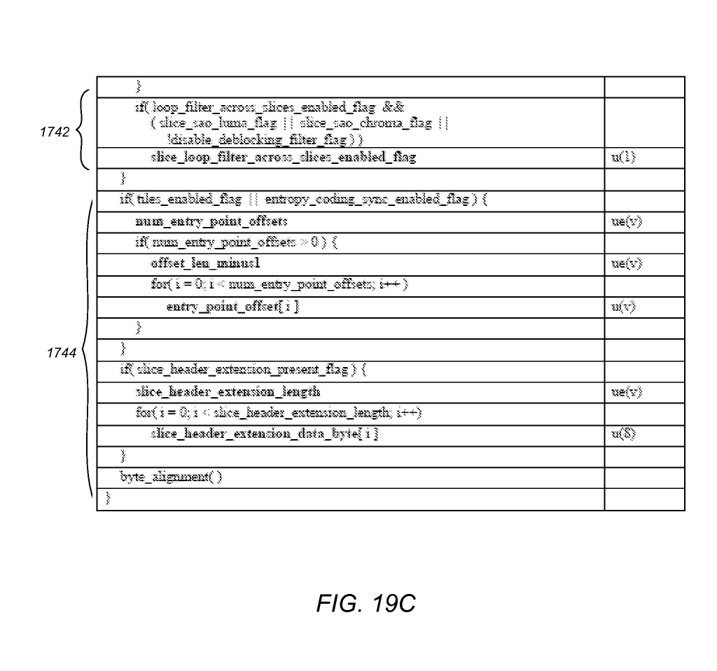

FIGS. 19A through 19C are diagrams illustrating one embodiment of the improved slice header syntax. The syntax shown in FIG. 19A is identical to the syntax discussed with respect to FIG. 17A. However, the improved slice header syntax depicted in FIG. 19B is modified from the baseline slice header syntax depicted in FIG. 17B. The baseline slice header syntax shown in FIG. 17B includes a conditional statement that determines whether the weighted_pred_flag is set and the slice is a P slice or if the weighted_bipred_flag is set and the slice is a B slice. If either is true, then the predicted weight table is read. The modified slice header weighted_biprediction syntax 1902, however, reads the weighted_prediction flag that signals the application of weighted prediction for both P and B slices and, if this flag is set, reads the prediction weight table and applies the predicted weights. The remainder of the improved slice header syntax is unchanged from that of the baseline slice header.

As described above, the improved weighted prediction syntax removes two flags from the PPS syntax (one for P slices and one for B slices) and substitutes a single flag for both P and B slices in the slice header syntax. As a result, the flags controlling weighted prediction processing and the weighted prediction parameters are on the same hierarchical levels of coding (picture versus slice), logical processing redundancies are reduced, and in most circumstances, bits are conserved.

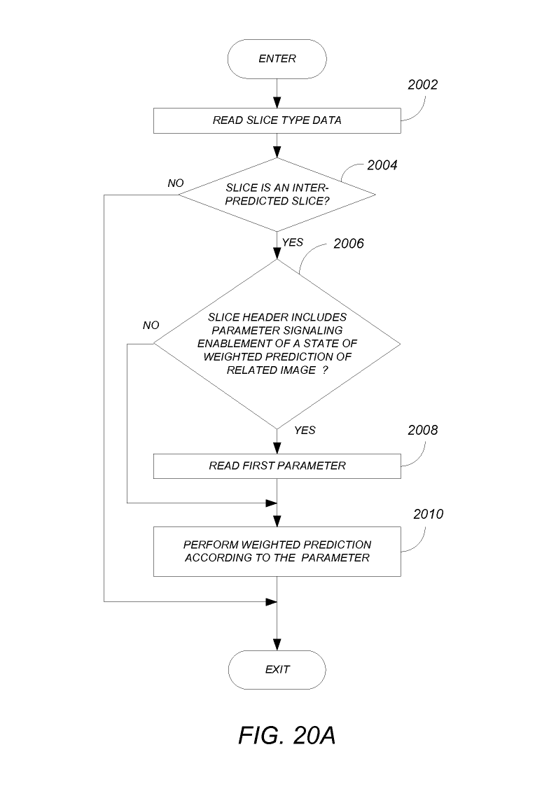

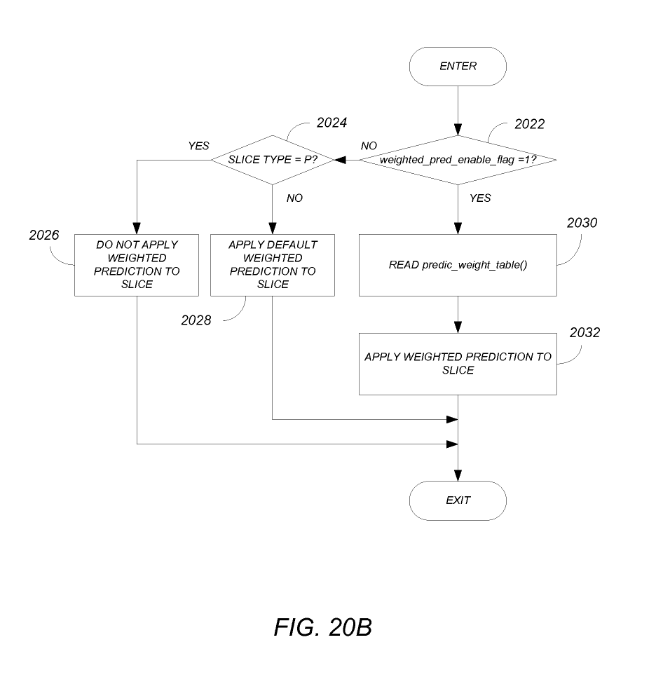

FIGS. 20A and 20B are diagrams further illustrating the slice header syntax logic. Turning first to FIG. 20A, block 2002 reads slice-type data. In one embodiment, the slice-type data are read from the slice header using syntax 1710. Block 2004 determines whether the slice is an inter-predicted slice such as a P slice or a B slice. This may be implemented using slice header syntax 1715, for example. If the slice is not an inter-predicted slice, weighted prediction is not implemented, and in the exemplary syntax illustrated in FIG. 19B, processing bypasses syntax 1716 through 1738 and is passed to syntax 1740. If the slice is an inter-predicted slice, processing is routed to block 2006, which determines whether the slice header includes a parameter signaling enablement of a state of weighted predication of the related image of the slice. If such parameter is present in the slice header, then it is read and used to perform weighted prediction according to the read parameter, as shown in blocks 2008 and 2010. If there is no parameter in the slice header, then processing is routed to block 2010, where default weighted prediction processing is performed for B slices but not P slices, as further described below.

FIG. 20B is a diagram further illustrating the weighted prediction processing. Block 2022 determines whether the weighted_pred_flag has a value of logical 1. If so, blocks 2030 and 2032 read the pred_weight_table and apply weighted prediction to the slice. If block 2022 does not determine that the weighted_pred_enable_flag has a value of a logical 1 (either because it is set to a logical 0 or is not present and inferred to be logical 0), then processing is passed to block 2024, which determines if the slice is a P-type slice. If the slice is a P-type slice, then weighted prediction is not applied to the image data of the slice, as shown in block 2026. If the slice is not a P-slice (and hence, is a B-slice by virtue of block 2004 determining that the slice is either a P-slice or a B-slice), then default weighted prediction is applied to the slice, as shown in block 2028.

Although the foregoing illustrates the reading of the weighted_pred_enable_flag immediately before the logical syntax using that flag, the weighted_pred_enable_flag may instead be read from other portions of the slice header. In particular, the weighted_pred_enable_flag may be read directly after the slice header syntax that determines if the slice is an inter-predicted slice (e.g., slice header syntax 1715).

The foregoing operations are described with respect to a decoding process, which can take place in either the source decoder 220 or an encoder 202, as a part of the encoding process. The encoding process may also be expressed as comprising determining if a slice of the one or more slices is an inter-predicted slice according to slice-type data, and if the slice is an inter-predicted slice, then configuring a first parameter in the slice header associated with the slice to a value signaling enablement of a state of weighted prediction of image data associated with the slice.

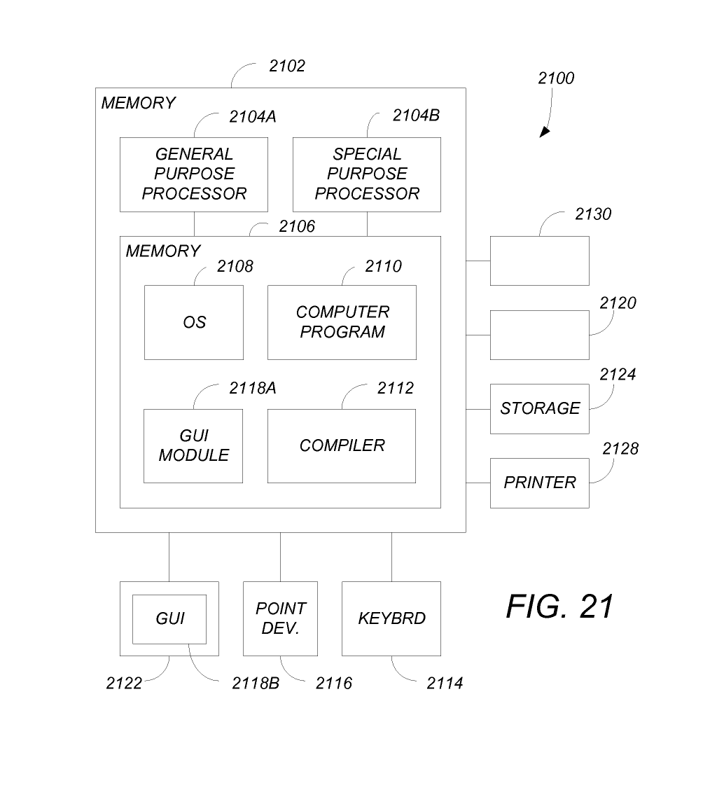

FIG. 21 illustrates an exemplary processing system 2100 that could be used to implement the embodiments of the invention. The computer 2102 comprises a processor 2104A,B and a memory, such as 2106. The computer 2102 is operatively coupled to a display 2122, which presents images such as windows to a user on a graphical user interface (“GUI”) 2118B. The computer 2102 may be coupled to other devices, such as a keyboard 2114, a mouse 2116, a printer, etc. Of course, those skilled in the art will recognize that any combination of the above components, or any number of different components, peripherals, and other devices, may be used with the computer 2102.

Generally, the computer 2102 operates under control of an operating system 2108 stored in the memory 2106 and interfaces with the user to accept inputs and commands and to present results through the GUI module 2118A. Although the GUI module 2118A is depicted as a separate module, the instructions performing the GUI functions can be resident or distributed in the operating system 2108, the computer program 2110, or implemented with special purpose memory and processors. The computer 2102 also implements a compiler 2112 which allows an application program 2110 written in a programming language to be translated into processor-readable code. After completion, the application 2110 accesses and manipulates data stored in the memory 2106 of the computer 2102 using the relationships and logic that were generated using the compiler 2112. The computer 2102 also optionally comprises an external communication device such as a modem, satellite link, Ethernet card, or other device for communicating with other computers.

In one embodiment, instructions implementing the operating system 2108, the computer program 2110, and the compiler 2112 are tangibly embodied in a computer-readable medium, e.g., in data-storage device 2120, which could include one or more fixed or removable data storage devices, such as a zip drive, floppy disc drive 2124, hard drive, CD-ROM drive, tape drive, etc. Further, the operating system 2108 and the computer program 2110 comprise instructions which, when read and executed by the computer 2102, cause the computer 2102 to perform the steps necessary to implement or use the invention. Computer program 2110 or operating instructions may also be tangibly embodied in memory 2106 or data communications devices 2130, thereby making a computer program product or article of manufacture.

The processing system 2100 may also be embodied in a desktop, laptop, tablet, notebook computer, personal digital assistant, cellphone, smartphone, or any device with suitable processing and memory capability. Further, the processing system 2100 may utilize special purpose hardware to perform some or all of the foregoing functionality. For example the encoding and decoding processes described above may be performed by a special purpose processor and associated memory.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. In a processing device for decoding a sequence comprising a plurality of pictures, each of the plurality of pictures partitionable into one or more slices, each of the pictures processed at least in part according to a picture parameter set, and each of the slices processed at least in part according to a slice header, a method of processing the sequence, the method comprising:
determining if a slice of the one or more slices is an inter-predicted slice according to slice-type data, wherein:
the slice is a B-type slice if the at least one coding unit of the slice is coded using motion vector compensation according to up to two motion vectors associated with at least one reference picture;
the slice is a P-type slice if at least one coding unit of the slice is coded using motion vector compensation according to no more than one motion vector associated with the at least one reference picture;
the slice is an I-type slice if no coding units of the slice are coded using motion vector compensation; and
the slice is an inter-predicted slice only if it is a P-type slice or a B-type slice; and
if the slice is determined to be an inter-predicted slice:
determining if a first parameter is in the slice header, the first parameter associated with a value signaling enablement of a state of weighted prediction of image data associated with the slice; and
if the first parameter is in the slice header:
reading the first parameter; and
performing weighted prediction of the image data according to the read first parameter.

2. The method of claim 1 further comprising:
determining if the read first parameter has a first value;
if the read first parameter has the first value:
disabling weighted prediction of the image data associated with the slice if the slice is a P-slice; and
performing weighted prediction of the image data associated with the slice according to a default weighted prediction if the slice is a B-slice; and
determining if the read first parameter has a second value;
if the read first parameter has the second value:
performing weighted prediction of the image data associated with the slice whether the slice is a P-slice or a B-slice.

3. The method of claim 2 further comprising:
if the first parameter is not in the slice header:
disabling weighted prediction of the image data associated with the slice if the slice is a P-slice; and
performing weighted prediction of the image data associated with the slice according to a default weighted prediction if the slice is a B-slice.

4. The method of claim 2 wherein the first parameter is a single flag and wherein the first value is a logical zero and the second value is logical one.

5. The method of claim 2 wherein performing weighted prediction of the image data associated with the slice whether the slice is a P-slice or a B-slice comprises:
reading weighted prediction data; and
applying the weighted prediction data to the image data.

6. The method of claim 1 wherein the slice-type data are read from the slice header associated with the slice.

7. In a processing device for encoding a sequence comprising a plurality of pictures, each of the plurality of pictures partitionable into one or more slices, each of the pictures processed at least in part according to a picture parameter set, and each of the slices processed at least in part according to a slice header, a method of processing the sequence, the method comprising:
determining if a slice of the one or more slices is an inter-predicted slice according to slice-type data, wherein:
the slice is a B-type slice if the at least one coding unit of the slice is coded using motion vector compensation according to up to two motion vectors associated with at least one reference picture;
the slice is a P-type slice if at least one coding unit of the slice is coded using motion vector compensation according to no more than one motion vector associated with the at least one reference picture;
the slice is an I-type slice if no coding units of the slice are coded using motion vector compensation; and
the slice is an inter-predicted slice only if it is a P-type slice or a B-type slice; and
if the slice is an inter-predicted slice, configuring a first parameter in the slice header associated with the slice to a value signaling enablement of a state of weighted prediction of image data associated with the slice.

8. The method of claim 7 wherein:
the configuring the first parameter comprises:
setting the first parameter to a first state to enable a first state of weighted prediction in which:
weighted prediction of the image data associated with the slice is disabled if the slice is a P-slice; and
weighted prediction of the image data associated with the slice is performed according to a default weighted prediction if the slice is a B-slice; and
setting the first parameter to a second value enabling a second value to enable a second state of weighted prediction in which:
weighted prediction of the image data associated with the slice is enabled whether the slice is a P-slices or a B-slice.

9. The method of claim 7 further comprising:
determining if the first parameter is set to the value signaling enablement of the weighted prediction of the image data associated with the slice; and
if the first parameter is set to the value signaling enablement of the weighted prediction of the image data associated with the slice, writing weighted prediction data.

10. The method of claim 9 wherein the weighted prediction data are a weighted prediction table.

11. An apparatus for encoding a sequence comprising a plurality of pictures, each of the plurality of pictures partitionable into one or more slices, each of the pictures processed at least in part according to a picture parameter set, and each of the slices processed at least in part according to a slice header, the apparatus comprising:
a processor;
a memory, communicatively coupled to the processor, the memory storing instructions comprising instructions for:
determining, if a slice of the one or more slices is an inter-predicted slice according to slice-type data, wherein:
the slice is a B-type slice if the at least one coding unit of the slice is coded using motion vector compensation according to up to two motion vectors associated with at least one reference picture;
the slice is a P-type slice if at least one coding unit of the slice is coded using motion vector compensation according to no more than one motion vector associated with the at least one reference picture;
the slice is an I-type slice if no coding units of the slice are coded using motion vector compensation; and
the slice is an inter-predicted slice only if it is a P-type slice or a B-type slice; and
if the slice is an inter-predicted slice, configuring a first parameter in the slice header associated with the slice to a value signaling enablement of a state of weighted prediction of image data associated with the slice.

12. The apparatus of claim 11 wherein:
configuring the first parameter comprises:
setting the first parameter to a first state to enable a first state of weighted prediction in which:
weighted prediction of the image data associated with the slice is disabled if the slice is a P-slice; and
weighted prediction of the image data associated with the slice is performed according to a default weighted prediction if the slice is a B-slice; and
setting the first parameter to a second value enabling a second value to enable a second state of weighted prediction in which:
weighted prediction of the image data associated with the slice is enabled whether the slice is a P-slices or a B-slice.

13. The apparatus of claim 11 wherein the instructions further comprise:
determining if the first parameter is set to the value signaling enablement of the weighted prediction of the image data associated with the slice; and
if the first parameter is set to the value signaling enablement of the weighted prediction of the image data associated with the slice, writing weighted prediction data.
